(19) United States
(12) Patent Application Publication
(10) Pub. No.: US 2023/0362871 A1
(43) Pub. Date: Nov. 9, 2023

(54) METHODS AND APPARATUS FOR LOCATION OF A USER EQUIPMENT ACCESSING A MOBILE BASE STATION RELAY

(71) Applicant: QUALCOMM Incorporated, San Diego, CA (US)

(72) Inventors: Stephen William EDGE, Escondido, CA (US); Hanna LIM, Seongnam-si (KR); Hong CHENG, Basking Ridge, NJ (US)

(21) Appl. No.: 18/312,363

(22) Filed: May 4, 2023

Related U.S. Application Data
(60) Provisional application No. 63/338,882, filed on May 5, 2022.

(51) Int. Cl. H04W 64/00; H04L 5/00; G01S 5/02

(52) U.S. Cl. CPC H04W 64/00; H04L 5/0051; G01S 5/0242; G01S 5/0249

(57) ABSTRACT

Techniques are disclosed for supporting positioning of a target user equipment (UE) that accesses a wireless network via a mobile base station relay (MBSR). The MBSR functions as an Integrated Access and Backhaul (IAB) node accessing the wireless network via a donor base station. The MBSR receives a request for positioning information from a location server via the donor base station related to positioning of the target UE. After determining the positioning information by performing positioning functions of a base station, the MBSR returns the positioning information to the location server via the donor base station, where the positioning information enables positioning of the UE. The location server determines a location of the target UE based at least partially on the positioning information received from the MBSR.

### RELATED APPLICATIONS

This application claims the benefit of U.S. Provisional Application No. 63/338,882, filed May 5, 2022, entitled “METHODS AND APPARATUS FOR LOCATION OF USER EQUIPMENT ACCESSING A VEHICLE MOUNTED RELAY”, which is assigned to the assignee hereof, and incorporated herein in its entirety by reference.

### BACKGROUND OF THE DISCLOSURE

### Field of the Disclosure

The following relates generally to wireless communications, and more specifically to techniques for supporting location services for user equipments (UEs) in a wireless network.

### Relevant Background

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth-generation (4G) systems such as Long-Term Evolution (LTE) systems, LTE-Advanced (LTE-A) systems, or LTE-A Pro systems, and fifth-generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

Location of wireless devices, including objects or entities associated with wireless devices, that are accessing a 4G, 5G (or later 6G) wireless network may be important for many applications. These can include: locating the user of an emergency call; finding people (e.g. relatives, friends, employees); tracking objects and assets; locating vehicles, ships, airplanes and drones; and coordinating and managing the movement of objects, machinery, tools and packages in a factory or warehouse. Methods for locating wireless devices can make use of a location server in a wireless network where the location server assists with locating wireless devices by providing location related assistance data to the wireless devices and/or receives location related measurements for wireless device and calculates locations of the wireless devices. In scenarios where a wireless device is accessing a wireless network via another wireless device that is acting as a relay, additional procedures may be needed to locate the wireless device beyond those normally used to locate a wireless device that is directly accessing a wireless network without the assistance of a relay.

### SUMMARY

Techniques and apparatus are disclosed for supporting positioning of a target user equipment (UE) that access a wireless network via a mobile base station relay (MBSR). The MBSR functions as an Integrated Access and Backhaul (IAB) node accessing the wireless network via a donor base station and providing the target UE with access to the wireless network via the MBSR and donor base station. The MBSR receives a request for positioning information from a location server via the donor base station related to positioning of the target UE. After determining the positioning information by performing positioning functions of a base station, the MBSR returns the positioning information to the location server via the donor base station, wherein the positioning information enables positioning of the UE. The location server determines a location of the target UE based on at least partially on the positioning information received from the MBSR.

In one implementation, a method performed by a mobile base station relay (MBSR) in a wireless network for positioning of a target user equipment (UE), the method includes receiving a request for positioning information from a location server via a donor gNB related to positioning of the target UE, the target UE accessing the wireless network via the MBSR; determining the positioning information by performing positioning functions of a gNB; and returning the positioning information to the location server via the donor gNB, wherein the positioning information enables positioning of the UE.

In one implementation, a mobile base station relay (MBSR) in a wireless network configured for positioning of a target user equipment (UE), includes an external interface configured to wirelessly communicate with entities in a wireless network; at least one memory; at least one processor coupled to the external interface and the at least one memory, wherein the at least one processor is configured to: receive a request for positioning information from a location server via a donor gNB related to positioning of the target UE, the target UE accessing the wireless network via the MBSR; determine the positioning information by performing positioning functions of a gNB; and return the positioning information to the location server via the donor gNB, wherein the positioning information enables positioning of the UE.

In one implementation, a mobile base station relay (MBSR) in a wireless network configured for positioning of a target user equipment (UE), includes means for receiving a request for positioning information from a location server via a donor gNB related to positioning of the target UE, the target UE accessing the wireless network via the MBSR; means for determining the positioning information by performing positioning functions of a gNB; and means for returning the positioning information to the location server via the donor gNB, wherein the positioning information enables positioning of the UE.

In one implementation, a non-transitory storage medium including program code stored thereon, the program code is operable to configure at least one processor in mobile base station relay (MBSR) in a wireless network configured for positioning of a target user equipment (UE), the program code comprising instructions to: receive a request for positioning information from a location server via a donor gNB related to positioning of the target UE, the target UE accessing the wireless network via the MBSR; determine the positioning information by performing positioning functions of a gNB; and return the positioning information to the location server via the donor gNB, wherein the positioning information enables positioning of the UE.

In one implementation, a method performed by a donor gNB in a wireless network for positioning of a target user equipment (UE), the method includes receiving a request for positioning information from a location server related to positioning of the target UE; sending the request for positioning information to a mobile base station relay (MBSR) used by the target UE to access the wireless network; receiving from the MBSR the positioning information; and sending the positioning information to the location server, wherein the positioning information enables positioning of the UE.

In one implementation, a donor gNB in a wireless network configured for positioning of a target user equipment (UE), includes an external interface configured to wirelessly communicate with entities in a wireless network; at least one memory; at least one processor coupled to the external interface and the at least one memory, wherein the at least one processor is configured to: receive a request for positioning information from a location server related to positioning of the target UE; send the request for positioning information to a mobile base station relay (MBSR) used by the target UE to access the wireless network; receive from the MBSR the positioning information; and send the positioning information to the location server, wherein the positioning information enables positioning of the UE.

In one implementation, a donor gNB in a wireless network configured for positioning of a target user equipment (UE), includes means for receiving a request for positioning information from a location server related to positioning of the target UE; means for sending the request for positioning information to a mobile base station relay (MBSR) used by the target UE to access the wireless network; means for receiving from the MBSR the positioning information; and means for sending the positioning information to the location server, wherein the positioning information enables positioning of the UE.

In one implementation, a non-transitory storage medium including program code stored thereon, the program code is operable to configure at least one processor in a donor gNB in a wireless network for positioning of a target user equipment (UE), the program code comprising instructions to: receive a request for positioning information from a location server related to positioning of the target UE; send the request for positioning information to a mobile base station relay (MBSR) used by the target UE to access the wireless network; receive from the MBSR the positioning information; and send the positioning information to the location server, wherein the positioning information enables positioning of the UE.

In one implementation, a method performed by a location server in a wireless network for positioning of a target user equipment (UE), the method includes sending a request for positioning information related to positioning of the target UE to a mobile base station relay (MBSR) via a donor gNB, the target UE accessing the wireless network via the MBSR; receiving from the MBSR via the donor gNB the positioning information; and determining a location of the target UE based on at least partially on the positioning information received from the MBSR.

In one implementation, a location server in a wireless network configured for positioning of a target user equipment (UE), includes an external interface configured to wirelessly communicate with entities in a wireless network; at least one memory; at least one processor coupled to the external interface and the at least one memory, wherein the at least one processor is configured to: send a request for positioning information related to positioning of the target UE to a mobile base station relay (MBSR) via a donor gNB, the target UE accessing the wireless network via the MBSR; receive from the MBSR via the donor gNB the positioning information; and determine a location of the target UE based on at least partially on the positioning information received from the MBSR.

In one implementation, a location server in a wireless network configured for positioning of a target user equipment (UE), includes means for sending a request for positioning information related to positioning of the target UE to a mobile base station relay (MBSR) via a donor gNB, the target UE accessing the wireless network via the MBSR; means for receiving from the MBSR via the donor gNB the positioning information; and means for determining a location of the target UE based on at least partially on the positioning information received from the MBSR.

In one implementation, a non-transitory storage medium including program code stored thereon, the program code is operable to configure at least one processor in a location server in a wireless network for positioning of a target user equipment (UE), the program code comprising instructions to: send a request for positioning information related to positioning of the target UE to a mobile base station relay (MBSR) via a donor gNB, the target UE accessing the wireless network via the MBSR; receive from the MBSR via the donor gNB the positioning information; and determine a location of the target UE based on at least partially on the positioning information received from the MBSR.

### BRIEF DESCRIPTION OF THE DRAWINGS

An understanding of the nature and advantages of various embodiments may be realized by reference to the following figures.

FIG. 1 illustrates an example of a wireless communications system that supports one or more aspects of the present disclosure.

FIG. 2 shows an example of a communication system, illustrating the overall architecture of a Next Generation (NG) Radio Access Network (RAN).

FIG. 3 shows an example of a communication system, illustrating the overall architecture of Integrated Access and Backhaul (IAB) nodes.

FIG. 4 shows an example of an environment including a mobile base station relay (MBSR) that functions as an IAB node and provides a target user equipment (UE) with access to a wireless network via a donor base station.

FIG. 5 shows an example of a communication system, illustrating the overall architecture of an NG-RAN that includes one or more IAB nodes which may be MBSRs.

FIG. 6A is a diagram of a control plane protocol stack between IAB nodes.

FIG. 6B is a diagram of a control plane protocol stack between a target UE and a location server, where the UE has MBSR access to a network using IAB nodes.

FIG. 7 is a signal flow illustrating a simplified exemplary procedure for positioning of a target UE accessing a location server via a MBSR and donor base station.

FIG. 8 is a signal flow illustrating a more detailed exemplary procedure for positioning of a target UE accessing a location server via a MBSR and donor base station.

FIG. 9 shows a schematic block diagram illustrating certain exemplary features of a hardware implementation of a MBSR.

FIG. 10 shows a schematic block diagram illustrating certain exemplary features of a hardware implementation of a donor base station.

FIG. 11 shows a schematic block diagram illustrating certain exemplary features of a hardware implementation of a location server.

FIG. 12 shows a flowchart for an exemplary method for positioning of a target UE, performed by a MBSR in a wireless network.

FIG. 13 shows a flowchart for an exemplary method for positioning of a target UE, performed by a donor gNB in a wireless network.

FIG. 14 shows a flowchart for an exemplary method for positioning of a target UE, performed by a location server in a wireless network.

Like reference numbers and symbols in the various figures indicate like elements, in accordance with certain example implementations. In addition, multiple instances of an element may be indicated by following a first number for the element with a letter or with a hyphen and a second number. For example, multiple instances of an element 110 may be indicated as 110a, 110b, 110c etc. When referring to such an element using only the first number, any instance of the element is to be understood (e.g. elements 110 in the previous example would refer to elements 110a, 110b and 110c).

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next-generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal.

To assist UE access to a 5G (e.g. NR) network, support can be added to allow a UE to access the 5G network via a mobile base station relay (MBSR), which may also be known as a vehicle-mounted relay (VMR). The MBSR may function as an Integrated Access and Backhaul (IAB) node, where the IAB node accesses the 5G network as a normal UE via a donor gNB but also supports a gNB Distributed Unit (DU) capability. The gNB DU capability of the MBSR is used to allow another UE to see the MBSR as a gNB and to access the 5G Network via the MBSR (and the donor gNB). There may be difficulties in obtaining a location for a UE that is accessing a MBSR because it would be unlikely that the UE would be able to access and obtain positioning measurements using other gNBs (otherwise the UE would be able to access one of those other gNBs and would not need to access the MBSR). Because the MBSR is vehicle mounted and may be moving, locating the UE using MBSR measurements of the UE and/or UE measurements of the MBSR could be highly error-prone. An MBSR could be attached to or mounted in or on a vehicle (e.g. a car, bus or truck), a ship, a drone, a balloon (e.g. hot air or helium balloon), an airplane, a helicopter, or some other mobile object or entity. In such cases, the solutions described herein may be used to locate a UE accessing the MBSR.

To enable accurate location of a UE accessing a MBSR a solution may have one or more of the following principles. The location determination may be based on using Round Trip Tim (RTT) and Angle of Arrival (AOA) measurement between the UE and MBSR, where the MBSR location may be provided by the MBSR (to a location server, such as a Location Management Function (LMF)) for the time when the MBSR measures RTT and can be derived by the location server for the time when the UE measures RTT. Accordingly, the MBSR may need to support some gNB positioning capability. The capabilities of the MBSR to enable accurate location of the UE, for example, may include an ability to function as a gNB Transmission-Reception Point (TRP), e.g., an ability to transmit downlink (DL) positioning reference signals (PRS) (DL-PRS) and measure uplink (UL) PRS, sometimes referred to as sounding reference signals (SRS), or SRS for positioning or UL SRS. The MBSR may include an ability to support on-demand transmission or PRS that may be time aligned/synchronized with PRS transmission from the donor gNB. The MBSR for example, may obtain timing from the donor gNB. The PRS synchronization may be in error by at least 10 μs (maybe 50 μs) which means distance-related timing errors would be less important. The MBSR may have a Global Navigation Satellite System (GNSS) receiver to enable accurate self-location.

To support accurate location of the UE accessing a MBSR, a location server may obtain MBSR positioning capabilities via the donor gNB using a positioning protocol, such as New Radio Position Protocol A (NRPPa) with enhancements. The location server may request DL PRS transmission by the MBSR and UL SRS transmission by the UE using a positioning protocol, such as NRPPa. The location server may request RTT reception to transmission difference (Rx-Tx) measurements by the target UE of the MBSR DL PRS using a positioning protocol, such as Long-Term Evolution (LTE) Positioning Protocol (LPP), and requests RTT Rx-Tx and possibly AOA measurements of the UE UL SRS by the MBSR using a positioning protocol, such as NRPPa. The UE may measure the DL PRS from the MBSR and send the Rx-Tx measurement to the location server. The MBSR may measure the UL SRS from the UE and send the Rx-Tx (and maybe AOA) measurement to the location server via the donor gNB control unit (CU) (gNB CU) using a positioning protocol, such as F1AP, (to the donor gNB CU) and then a positioning protocol, such as NRPPa, to the location server. The MBSR may also provide the location server with the MBSR location and possibly velocity at the time of UL SRS measurement, which may be simplified if the MBSR includes a GNSS receiver (e.g. able to measure and determine the MBSR location and velocity using GNSS measurements) and has GNSS access. The MBSR may also provide the location server with a location history. The location server may also or instead request earlier/later locations from the MBSR (e.g., using a positioning protocol, such as NRPPa). The location server may use the MBSR location and velocity information to determine the MBSR location at the time of UE measurement of MBSR DL PRS to compensate for any difference in location between when measurements of the UE were obtained by the MBSR and when measurements of the UE were obtained by the MBSR. The location server may request other gNBs to measure the UE UL SRS and the UE to measure DL PRS from the other gNBs as for a multi-cell RTT positioning method. Details of the foregoing are provided herein.

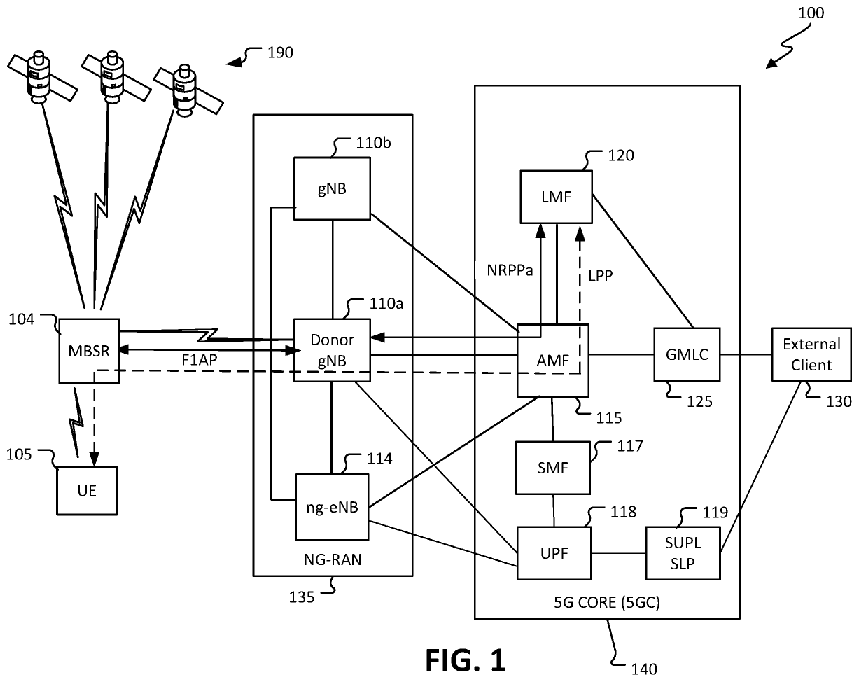

FIG. 1 shows an example of the architecture of a communication system 100 that includes a MBSR 104, UE 105, a Radio Access Network (RAN) 135, here a Fifth Generation (5G) Next Generation (NG) RAN (NG-RAN), and a 5G Core Network (5GC) 140. The 5GC 140, for example, may be a public land mobile network (PLMN). A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The RAN 135 may be another type of RAN, e.g., a 3G RAN, a 4G Long Term Evolution (LTE) RAN, etc.

The MBSR 104 may function as an IAB node and accesses the 5GC 140 as a normal UE via the donor gNB 110a, and also supports gNB DU capability allowing UE 105 to see the MBSR 104 as a gNB, with the UE 105 accessing the 5GC 140 via the MBSR 104 and the donor gNB 110a. The UE 105, for example, may be, e.g., an internet of things (IoT) device, a location tracker device, a cellular telephone, smartphone, tablet computer, etc. with wireless capabilities. The MBSR 104 and UE 105 may both be configured to send and/or receive signals to/from similar other entities in the system 100. In FIG. 1, however, the UE 105 is illustrated with a wireless connection with the MBSR 104, through which access to the 5GC 140 is obtained. The communication system 100 may utilize information from a constellation of satellite vehicles (SVs) 190 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125, a User Plane Function (UPF) 118, and a Secure User Plane Location (SUPL) Location Platform (SUPL SLP) 119. The gNBs 110a, 110b and the ng-eNB 114 are communicatively coupled to each other, are each configured wirelessly communicate to bi-directionally with UEs (the donor gNB 110a views the MBSR 104 as a normal UE, and accordingly, the MBSR 104 may sometimes be generally referred to as a UE), and are each communicatively coupled to, and configured to bi-directionally communicate with, the AMF 115 and the UPF 118. The gNBs 110a, 110b, and the ng-eNB 114 may be referred to as base stations (BSs). The AMF 115, the SMF 117, the LMF 120, and the GMLC 125 are communicatively coupled to each other, and the GMLC 125 is communicatively coupled to an external client 130. The AMF 115, the SMF 117, the UPF 118, and the SUPL SLP 119 are communicatively coupled to each other, and the SUPL SLP 119 is communicatively coupled to the external client 130. The SMF 117 may further serve as an initial contact point of a Service Control Function (SCF) (not shown) to create, control, and delete media sessions. The base stations 110a, 110b, 114 may be a macro cell (e.g., a high-power cellular base station), or a small cell (e.g., a low-power cellular base station), or an access point (e.g., a short-range base station configured to communicate with short-range technology such as WiFi (or Wi-Fi), WiFi-Direct (WiFi-D), Bluetooth, Bluetooth-low energy (BLE), Zigbee, etc. One or more of the base stations 110a, 110b, 114 may be configured to communicate with the UEs 105 via multiple carriers. Each of the base stations 110a, 110b, 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted, as necessary. Specifically, although only one MBSR 104 and one UE 105 are illustrated, many MBSRs and UEs (e.g., hundreds, thousands, millions, etc.) may be utilized in the communication system 100. Similarly, the communication system 100 may include a larger (or smaller) number of SVs (i.e., more or fewer than the four SVs 190 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at the MBSR 104 and UE 105 or at base stations 110a, 110b, 114 and/or provide location assistance to the MBSR 104 and UE 105 (via the LMF 120 or SUPL SLP 119 or other location server) and/or compute a location for one or both of the MBSR 104 and UE 105 at a location-capable device such as the MBSR 104, UE 105, the base stations 110a, 110b, the LMF 120, or SUPL SLP 119 based on measurement quantities received at the MBSR 104, UE 105 or the base stations 110a, 110b, 114 for such directionally-transmitted signals. The GMLC 125, the LMF 120, the AMF 115, the SMF 117, the UPF 118, the SUPL SLP 119, the ng-eNB (eNodeB) 114 and the gNBs (gNodeBs) 110a, 110b are examples and may, in various embodiments, be replaced by or include various other entities, including location server functionality and/or base station functionality.

The system 100 is capable of wireless communication in that components of the system 100 can communicate with one another (at least sometimes using wireless connections) directly or indirectly, e.g., via the base stations 110a, 110b, 114 and/or the network 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device but may communicate wirelessly and via wired connections. The UE 105 may be any of a variety of devices, e.g., a smartphone, a tablet computer, a vehicle-based device, etc., but these are examples only as the UE 105 is not required to be any of these configurations, and other configurations of UEs may be used. Other UEs may include wearable devices (e.g., smart watches, smart jewelry, smart glasses, or headsets, etc.). Still other UEs may be used, whether currently existing or developed in the future. Further, other wireless devices (whether mobile or not) may be implemented within the system 100 and may communicate with each other and/or with the UE 105, the base stations 110a, 110b, 114, the core network 140, and/or the external client 130. For example, such other devices may include IoT or IIoT devices, medical devices, home entertainment and/or automation devices, etc. The core network 140 may communicate with the external client 130 (e.g., a computer system), e.g., to allow the external client 130 to request and/or receive location information regarding the UE 105 (e.g., via the GMLC 125 or SUPL SLP 119).

The MBSR 104, UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UE 105 may communicate with other UEs through UE-to-UE sidelink (SL) communications by transmitting over one or more sidelink channels, such as a physical sidelink synchronization channel (PSSCH), a physical sidelink broadcast channel (PSBCH), a physical sidelink control channel (PSCCH), Synchronization Signal Block (SSB), sidelink channel state information reference signal (SL-CSIRS), physical sidelink feedback channel (PSFCH), or sidelink sounding reference signals (SL-SRS).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, tracking device, navigation device, Internet of Things (IoT) device, asset tracker, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125 or SUPL SLP 119).

An estimate of a location of a UE, e.g., UE 105, may be referred to as a location, location estimate, location fix, fix, position, position estimate, or position fix, and may be geographic, thus providing location coordinates for the UE (e.g., latitude and longitude) which may or may not include an altitude component (e.g., height above sea level, height above or depth below ground level, floor level, or basement level). Alternatively, a location of the UE may be expressed as a civic location (e.g., as a postal address or the designation of some point or small area in a building such as a particular room or floor). A location of the UE may be expressed as an area or volume (defined either geographically or in civic form) within which the UE is expected to be located with some probability or confidence level (e.g., 67%, 95%, etc.). A location of the UE may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth, and so on. One or more of a group of UE 105 utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas or may be otherwise unable to receive transmissions from a base station. Groups of UE 105 communicating via D2D communications may utilize a one-to-many (1:M) system in which each MBSR 104 may transmit to other UEs in the group. A TRP may facilitate scheduling of resources for D2D communications. In other cases, D2D communications may be carried out between UE 105 without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the MBSR 104 and UE 105 via wireless communication between the MBSR 104 (and UE 105 when UE 105 has direct access) and one or more of the gNBs 110a, 110b, which may provide wireless communications access to the 5GC 140 on behalf of the MBSR 104 (and the UE 105 when the UE 105 has direct access) using 5G. In FIG. 1, the donor gNB for the MBSR 104 is assumed to be the gNB 110a, while the serving gNB for the UE 105 (when the UE has direct access) may be gNB 110a or another gNB, such as gNB 110b.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the MBSR 104 and UE 105. One or more of the gNBs 110a, 110b and/or the ng-eNB 114 may be configured to function as positioning-only beacons which may transmit signals to assist with determining the position of the MBSR 104 and UE 105 but may not receive signals from the MBSR 104 and UE 105 or from other UEs.

The base stations 110a, 110b, 114 may each comprise one or more TRPs. For example, each sector within a cell of a base station may comprise a TRP, although multiple TRPs may share one or more components (e.g., share a processor but have separate antennas). The system 100 may include only macro TRPs or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Communications system 100 may support NR and support communications between the one or more base stations 110a, 110b, 114 and supported UEs 105. The UEs may be dispersed throughout the wireless communications system 100, and each UE may be stationary or mobile. As part of the communication, each of the base stations 110a, 110b, 114 and UEs 105 may support reference signal transmission for operations, including channel estimation, beam management and scheduling, and wireless device positioning within the coverage areas of one or more base stations.

For example, the base stations 110a, 110b, 114 may transmit one or more downlink reference signals for NR communications, including channel state information reference signal (CSI-RS) transmission. Each of the CSI-RS transmissions may be configured for a specific MBSR 104 and UE 105 to estimate the channel and report channel quality information. The reported channel quality information may be used for scheduling or link adaptation at the base stations 110a, 110b, 114 or as part of a mobility or beam management procedure for directional transmission associated with the enhanced channel resources. Similarly, the MBSR 104 and UE 105 may be configured to transmit uplink signals to one or more base stations 110a, 110b, 114 and sidelink transmissions between UEs 105.

The base stations 110a, 110b, 114, and the MBSR 104 may transmit one or more additional downlink reference signals, including a positioning reference signal (PRS) transmission. The PRS transmission may be configured for a specific UE 105 to measure and report one or more report parameters (for example, report quantities) associated with positioning and location information. The PRS transmission and report parameter feedback may support various location services (for example, navigation systems and emergency communications). In some examples, the report parameters supplement one or more additional location systems supported by the UE 105 (such as global positioning system (GPS) technology).

A base station 110a, 110b, 114, and MBSR 104 may configure a PRS transmission on one or more PRS resources of a channel. A PRS resource may span resource elements of multiple physical resource blocks (PRBs) within one or more OFDM symbols of a slot depending on a configured number of ports. For example, a PRS resource may span one symbol of a slot and contain one port for transmission. In any OFDM symbol, the PRS resources may occupy consecutive PRBs. In some examples, the PRS transmission may be mapped to consecutive OFDM symbols of the slot. In other examples, the PRS transmission may be mapped to interspersed OFDM symbols of the slot. Additionally, the PRS transmission may support frequency hopping within PRBs of the channel.

The one or more PRS resources may span a number of PRS resource sets according to a PRS resource setting of the base station 110a, 110b, 114, and MBSR 104. The structure of the one or more PRS resources, PRS resource sets, and PRS resource settings within a PRS transmission may be referred to as a multi-level resource setting. For example, multi-level PRS resource setting of the base station 110a, 110b, 114, and MBSR 104 may include multiple PRS resource sets and each PRS resource set may contain a set of PRS resources (such as a set of 4 PRS resources).

The UE 105 may receive the PRS transmission over the one or more PRS resources of the slot. The UE 105 may determine a report parameter for at least some of if not each PRS resource included in the transmission. The report parameter (which may include a report quantity) for each PRS resource may include one or more of a time of arrival (TOA), a reference signal time difference (RSTD), a reference signal receive power (RSRP), an angle, a PRS identification number, a reception to transmission difference (UE Rx-Tx), a signal-to-noise ratio (SNR), or a reference signal receive quality (RSRQ).

Similarly, the UE 105 may be configured to transmit one or more additional uplink reference signals that may be received by base stations 110a, 110b, 114, and MBSR 104 and used for positioning. For example, UE 105 may transmit sounding reference signal (SRS) for positioning. Base stations 110a, 110b, 114, and MBSR 104 that receive uplink reference signals from a UE 105 may perform positioning measurements, such as one or more of a time of arrival (TOA), reception to transmission difference (UE Rx-Tx), as well as Angle of Arrival (AOA).

Aspects of wireless communications system 100 may include use of downlink PRS transmissions by the base station 110a, 110b, 114 and MBSR 104 or uplink SRS transmissions by a UE 105 for UE location determination. For downlink-based UE location determination, a location server, e.g., LMF 120 in a NR network, or E-SMLC in LTE (sometimes referred to as location server 120), may be used to provide positioning assistance, such as PRS assistance data (AD) to the UE. For uplink-based UE location determination, a location server 120 and/or a serving base station, e.g., gNB 110a, may be used to provide positioning assistance, such as SRS assistance data, to receiving entities, such as base stations (e.g., gNBs 110a, 110b, and MBSR 104). The SRS assistance data, for example, may include the SRS transmission occasion and other parameters, e.g., such as the reference signal pattern, power if different from nominal, the number of repetitions, etc.

A position estimation of the UE may be determined using reference signals, such as PRS signals or SRS for positioning signals, or other reference signals, from one or more base stations 110a, 110b, 114 or the UE. Positioning methods, such as Time Difference of Arrival (TDOA), DL Time Difference of Arrival (DL-TDOA), DL Angle of Departure (DL AoD), Enhanced Cell ID (ECID) are position methods that may be used to estimate the position of the UE using reference signals from base stations. TDOA, for example, relies on measuring Reference Signal Time Differences (RSTDs) between downlink (DL) signals received from a base station for a reference cell and base station(s) for one or more neighbor cells. The DL signals for which RTSDs may be obtained comprise a Cell-specific Reference Signal (CRS) and a Positioning Reference Signal (PRS)—e.g., as defined in 3GPP TS 36.211.

Other positioning methods may use reference signals transmitted by the UE including uplink-based positioning methods and downlink and uplink-based positioning methods. For example, uplink-based positioning methods include, e.g., UL Time Difference of Arrival (UL-TDOA), UL Angle of Arrival (UL AoA), UL Relative Time of Arrival (UL-RTOA) and downlink and uplink-based positioning methods, e.g., Round-trip time (RTT) with one or more neighboring base stations. Additionally, sidelink-based positioning may be used in which UEs transmit and/or receive sidelink positioning reference signals that are measured and used for positioning.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b, and the ng-eNB 114 may communicate with the AMF 115, which, for positioning functionality, communicates with the LMF 120. The AMF 115 may support mobility of the UE 105, including cell change and handover, and may participate in supporting a signaling connection to the UE 105 and possibly data and voice bearers for the UE 105. The LMF 120 may communicate directly or indirectly with the UE 105, e.g., through wireless communications, or directly or indirectly with the base stations 110a, 110b, 114, and MBSR 104. The LMF 120 may support the positioning of the UE 105 when the UE 105 accesses the NG-RAN 135 and may support position procedures/methods such as Assisted GNSS (A-GNSS), Time Difference of Arrival (TDOA) (e.g., Downlink (DL) TDOA or Uplink (UL) TDOA), Real Time Kinematics (RTK), Precise Point Positioning (PPP), Differential GNSS (DGNSS), Enhanced Cell ID (E-CID), angle of arrival (AOA), angle of departure (AOD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value-added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SUPL SLP). At least part of the positioning functionality (including derivation of the location of the UE) may be performed at the UE (e.g., using signal measurements obtained by the UE for signals transmitted by wireless nodes such as the gNBs 110a, 110b, and/or the ng-eNB 114, and/or assistance data provided to the UE, e.g., by the LMF 120). At least part of the positioning functionality (including derivation of the location of the UE) alternatively may be performed at the LMF 120 (e.g., using signal measurements obtained by the gNBs 110a, 110b, and/or the ng-eNB 114. The AMF 115 may serve as a control node that processes the signaling between the UE 105 and the core network 140 and provides QoS (Quality of Service) flow and session management. The AMF 115 may support mobility of the UE 105 including cell change and handover and may participate in supporting signaling connection to the UE 105.

The GMLC 125 may support a location request for the UE 105 received from the external client 130 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130. The GMLC 125 is shown as connected to both the AMF 115 and LMF 120, though only one of these connections may be supported by the 5GC 140 in some implementations.

A User Plane Function (UPF) 118 may support voice and data bearers for UE 105 and may enable UE 105 voice and data access to other networks such as the Internet. The UPF 118 may be connected to gNBs 110 and ng-eNB 114. UPF 118 functions may include external Protocol Data Unit (PDU) session point of interconnect to a Data Network, packet (e.g. Internet Protocol (IP)) routing and forwarding, packet inspection and user plane part of policy rule enforcement, Quality of Service (QoS) handling for the user plane, downlink packet buffering and downlink data notification triggering. UPF 118 may be connected to the SUPL SLP 119 to enable support of positioning of UE 105 using SUPL. SUPL SLP 119 may be further connected to or accessible from external client 130.

As illustrated, a Session Management Function (SMF) 117 connects to the AMF 115 and the UPF 118. The SMF 117 may have the capability to control both a local and a central UPF within a PDU session. SMF 117 may manage the establishment, modification, and release of PDU sessions for UE 105, perform IP address allocation and management for UE 105, act as a Dynamic Host Configuration Protocol (DHCP) server for UE 105, and select and control a UPF 118 on behalf of UE 105.

As further illustrated in FIG. 1, the LMF 120 may communicate with the gNBs 110a, 110b, and/or the ng-eNB 114 using a New Radio Position Protocol A (NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. The donor gNB 110a may communicate with the MBSR 104 using F1AP. As further illustrated in FIG. 1, the LMF 120 and the UE 105 may communicate using an LTE Positioning Protocol (LPP), which may be defined in 3GPP TS 36.355. Here, LPP messages may be transferred between the UE 105 and the LMF 120 via the AMF 115 and the serving gNB 110a, 110b or the serving ng-eNB 114 for the UE 105, and in the example illustrated in FIG. 1, through the donor gNB 110a and MBSR 104. For example, LPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. Communication between the LMF 120 and UE 105 using LPP protocol, may sometimes referred to herein as direct communication, as the messages are transparent to the serving gNB, i.e., the serving gNB does not need to understand the content of the message, but simply forwards the communication between the LMF 120 and UE 105. In contrast, during communications using NPP protocol, such as NRPPa, the serving gNB unpacks the message and picks out the content, which is packed and sent to UE, e.g., in a Uu air interface via Radio Resource Control (RRC), Medium Access Control—Control Element (MAC-CE), Downlink Control Information (DCI), etc. The LPP protocol may be used to support the positioning of the UE 105 using UE-assisted and/or UE-based position methods such as A-GNSS, RTK, TDOA, AOA, AOD, and/or E-CID. The NRPPa protocol may be used to support the positioning of the UE 105 using network-based position methods such as E-CID (e.g., when used with measurements obtained by the gNB 110a, 110b, the ng-eNB 114, and MBSR 104) and/or may be used by the LMF 120 to obtain location related information from the gNBs 110a, 110b, the ng-eNB 114, and/or MBSR 104, such as parameters defining directional Synchronization Signal (SS) transmissions from the gNBs 110a, 110b, and/or the ng-eNB 114. The LMF 120 is illustrated in FIG. 1 as being located in the core network 140, but may be external to the core network 140, e.g., in an NG-RAN. For example, the LMF 120 may be co-located or integrated with a gNB or a TRP, or may be disposed remotely from the gNB and/or the TRP and configured to communicate directly or indirectly with the gNB and/or the TRP.

With a UE-assisted position method, the UE 105 may obtain location measurements and send the measurements to a location server (e.g., the LMF 120) for the computation of a location estimate for the UE. For example, the location measurements may include one or more of a Received Signal Strength Indication (RSSI), Round Trip signal propagation Time (RTT), Reference Signal Time Difference (RSTD), Reference Signal Received Power (RSRP), and/or Reference Signal Received Quality (RSRQ), AOA, AOD, for the gNBs 110a, 110b, the ng-eNB 114, MBSR 104 and/or a WLAN AP. The location measurements may also or instead include measurements of GNSS pseudorange, code phase, and/or carrier phase for the SVs 190-193.

With a UE-based position method, the UE 105, may obtain location measurements (e.g., which may be the same as or similar to location measurements for a UE-assisted position method) and may compute a location of the UE (e.g., with the help of assistance data received from a location server such as the LMF 120 or broadcast by the gNBs 110a, 110b, the ng-eNB 114, MBSR 104, or other base stations or APs).

With a network-based position method, one or more base stations (e.g., the gNBs 110a, 110b, and/or the ng-eNB 114 or MBSR 104), sidelink UEs, or APs may obtain location measurements (e.g., measurements of RSSI, RTT, RSRP, RSRQ, AOA, AOD, or Time of Arrival (ToA) for signals transmitted by the UE 105 and/or may receive measurements obtained by the UE. The one or more base stations, MBSR 104, or APs may send the measurements to a location server (e.g., the LMF 120) for computation of a location estimate for the UE.

Information provided by the gNBs 110a, 110b, the ng-eNB 114, and/or MBSR 104 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or TDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the MBSR 104 and donor gNB 110a (or via the serving gNB 110a) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 150. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support the positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

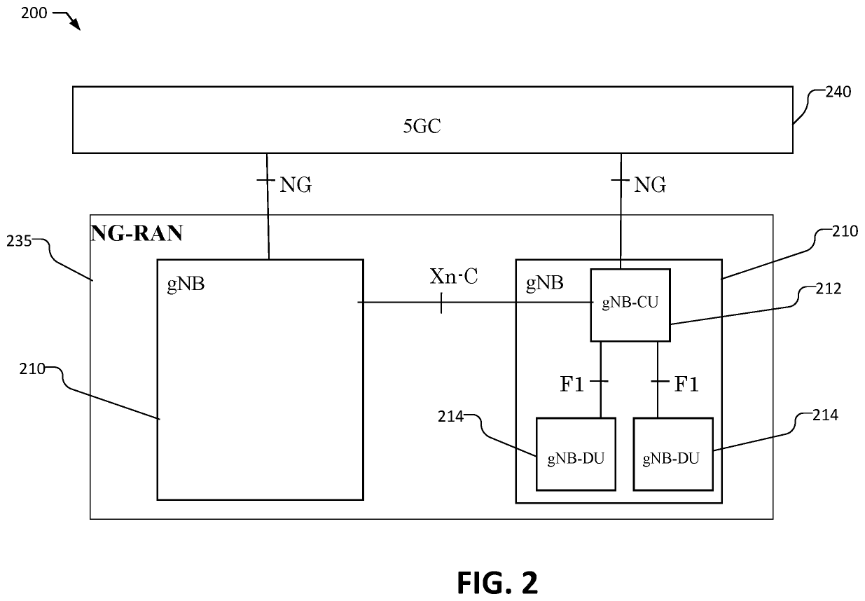

FIG. 2 shows an example of a communication system 200 illustrating the overall architecture of an NG-RAN 235, which may be, e.g., NG-RAN 135 shown in FIG. 1. The NG-RAN 235 consists of a set of gNBs 210, which may correspond to gNBs 110 in FIG. 1, connected to the 5GC 240, which may be the 5GC 140 shown in FIG. 1, through the NG interface.

The NG-RAN 235 may also include a set of ng-eNB s, where an ng-eNB may consist of an ng-eNB-CU and one or more ng-eNB-DU(s). An ng-eNB-CU and an ng-eNB-DU is connected via W1 interface. The general principle described in reference to FIG. 2 also applies to ng-eNB and W1 interface, if not explicitly specified otherwise.

An gNB 210 may support frequency division duplexing (FDD) mode, time division duplexing (TDD) mode, or dual mode operation. gNBs 210 may be interconnected through the Xn interface. A gNB may consist of a gNB-CU 210 and one or more gNB-DU(s) 214, in which case the gNB 210 may act as a donor gNB for IAB nodes including MBSRs. A gNB-CU and a gNB-DU are connected via F1 interface. One gNB-DU is connected to only one gNB-CU. In case of network sharing with multiple cell ID broadcast, each Cell Identity associated with a subset of PLMNs corresponds to a gNB-DU 214 and the gNB-CU 212 it is connected to, i.e. the corresponding gNB-DUs 214 share the same physical layer cell resources. For resiliency, a gNB-DU 214 may be connected to multiple gNB-CUs 212 by appropriate implementation. NG, Xn, and F1 are logical interfaces. For NG-RAN 235, the NG and Xn-C interfaces for a gNB consisting of a gNB-CU 212 and gNB-DUs 214, terminate in the gNB-CU 212. For EN-DC (Evolved-Universal Terrestrial Radio Access (E-UTRAN) New Radio—Dual Connectivity), the S1-U and X2-C interfaces for a gNB 210 consisting of a gNB-CU 212 and gNB-DUs 214, terminate in the gNB-CU 212. The gNB-CU 212 and connected gNB-DUs 214 are only visible to other gNBs and the 5GC 240 as a gNB 210. The node hosting user plane part of NR PDCP (Packet Data Convergence Protocol) (e.g. gNB-CU, gNB-CU-UP (User Plane), and for EN-DC, MeNB (master eNB) or SgNB (secondary gNB) depending on the bearer split) shall perform user inactivity monitoring and further informs its inactivity or (re)activation to the node having C-plane connection towards the core network (e.g. over E1, X2). The node hosting NR Radio Link Control (RLC) (e.g. gNB-DU 214) may perform user inactivity monitoring and further inform its inactivity or (re)activation to the node hosting control plane, e.g. gNB-CU or gNB-CU-CP (Control Plane), UL PDCP configuration (i.e. how the UE uses the UL at the assisting node) is indicated via X2-C (for EN-DC), Xn-C (for NG-RAN) and F1-C. Radio Link Outage/Resume for DL and/or UL is indicated via X2-U (for EN-DC), Xn-U (for NG-RAN), and F1-U. The NG-RAN is layered into a Radio Network Layer (RNL) and a Transport Network Layer (TNL). The NG-RAN architecture, i.e. the NG-RAN logical nodes and interfaces between them, is defined as part of the RNL. The TNL provides services for user plane transport, signaling transport. In the NG-Flex configuration, each NG-RAN node is connected to all AMFs of AMF Sets within an AMF Region supporting at least one slice also supported by the NG-RAN node. If security protection for control plane and user plane data on TNL of NG-RAN interfaces has to be supported, NDS/IP under 3GPP TS 33.501 is applied.

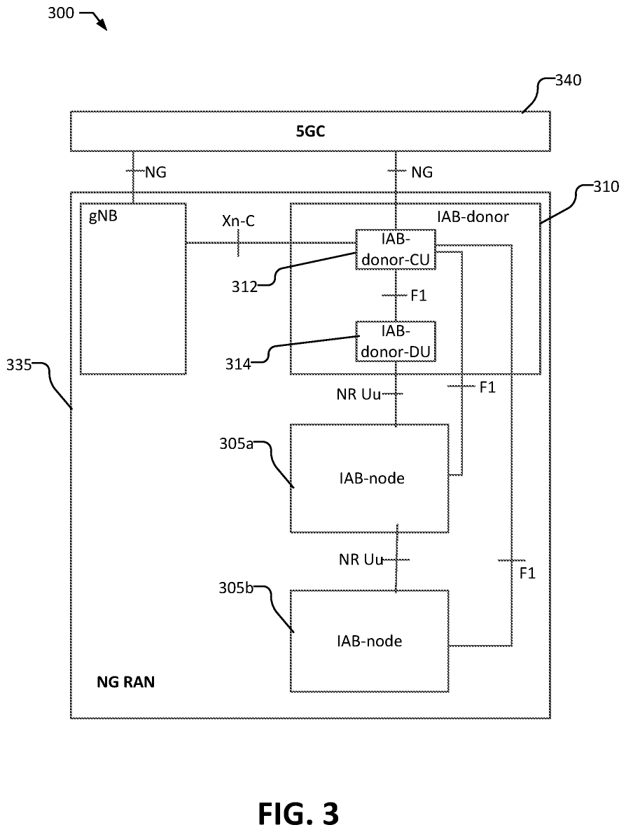

FIG. 3 shows an example of a communication system 300, illustrating the overall architecture of IAB nodes. The NG-RAN 335, which may be, e.g., the NG-RAN 135 shown in FIG. 1, supports one or more IAB-nodes 305a, 305b wirelessly connecting to a gNB 310 capable of serving the IAB-nodes, also named IAB-donor 310 or donor gNB 310, connected to the 5GC 340, which may be the 5GC 140 shown in FIG. 1, through the NG interface. The IAB-donor 310, which may correspond to gNB 210 in FIG. 2, consists of an IAB-donor-CU 312 and one or more IAB-donor-DU(s) 314. In case of separation of gNB-CU-CP and gNB-CU-UP, the IAB-donor 310 may consist of an IAB-donor-CU-CP, multiple IAB-donor-CU-UPs, and multiple IAB-donor-DUs. The IAB-node 305b connects to an upstream IAB-node 305a or an IAB-donor-DU 314 via a subset of the UE functionalities of the NR Uu interface (named IAB-MT function of IAB-node). The IAB-node 305a provides wireless backhaul to the downstream IAB-nodes 305b and UEs (not shown) via the network functionalities of the NR Uu interface (named IAB-DU function of IAB-node). The F1-C traffic between an IAB-node 305b and IAB-donor-CU 312 is backhauled via the IAB-donor-DU 314 and the optional intermediate hop IAB-node(s) 305a. The F1-U traffic between an IAB-node 305b and IAB-donor-CU 312 is backhauled via the IAB-donor-DU 314 and the optional intermediate hop IAB-node(s) 305a. The functions of a gNB-DU 314 may be equally applicable for an IAB-DU and IAB-donor-DU, and functions specified for a gNB-CU 312 may be equally applicable for an IAB-donor-CU. The functions for the UE context may be equally applicable for managing the context of IAB-MT.

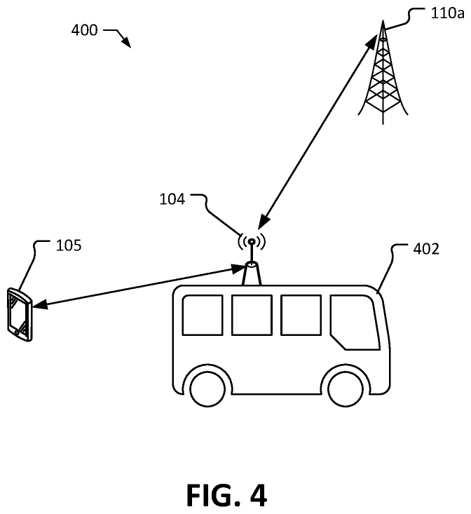

FIG. 4 shows an example of an environment 400 including the MBSR 104, which functions as an IAB node (e.g. IAB node 305a or 305b in FIG. 3), a donor base station (e.g. donor gNB) 110a, and a UE 105. The MBSR 104 is mounted to a vehicle 402, which may be moving with respect to the donor base station 110a. The UE 105 may be located in the vicinity of the vehicle 402, e.g., external to the vehicle 402 as illustrated in FIG. 4 so that the MBSR 104 moves with respect to the UE 105, or internally to the vehicle 402 so that the MBSR 104 and the UE move together.

The MBSR 104 functions as an IAB-node and can provide network coverage and communication to the UE 105 UE (inside the vehicle 402 and/or in its vicinity) and connected wirelessly to the network via IAB-donor gNB 110a. The UE 105 may be continuously served by the MBSR 104 which may move around within a limited geographical area while keeping connecting with the same IAB-donor gNB 110a. In another scenario, the MBSR 104 may move around over a long distance and may need to be connected with IAB-donor gNBs as the vehicle 402 moves, but the UE 105 may keep the connection with the MBSR 104.

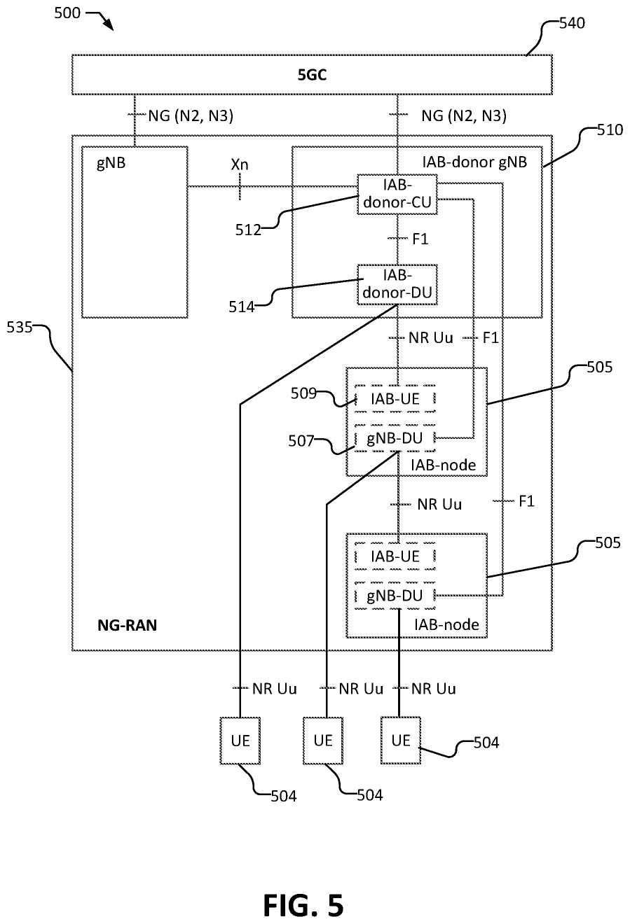

FIG. 5 shows an example of a communication system 500, illustrating the overall architecture of the NG-RAN 535, which may be the NG-RAN 135 shown in FIG. 1, and one or more MBSRs 104, which may be an IAB node mounted to a vehicle, as illustrated in FIG. 4. The architecture for the NG-RAN 535 and MBSR 505 may be similar to that discussed in FIG. 3, with one or more IAB nodes 505 that act as MBSRs wirelessly connecting to the IAB-donor (e.g. gNB) 510 connected to the 5GC 540, which may be the 5GC 140 shown in FIG. 1, through the NG interface. The IAB-donor 510 includes IAB-donor-CU 512 and one or more IAB-donor-DU(s) 514. When using the IAB architecture, the IAB node (MBSR) 505 consists of a gNB-DU function 507 and an IAB-UE function 509. For roaming, the IAB-UE function 509 behaves as a UE and thus may be able to access a virtual PLMN (VPLMN) reusing UE procedures. The gNB-DU function 507 in the MBSR 505 is responsible for providing NR Uu access to UEs 504 and child IAB-nodes. The corresponding gNB-CU 512 function resides on the IAB-donor gNB 510, which controls IAB-node gNB-DU 514 via the F1 interface. The MBSR 505 (IAB-node) appears as a normal gNB to UEs and other IAB-nodes and allows them to connect to the 5GC 540.

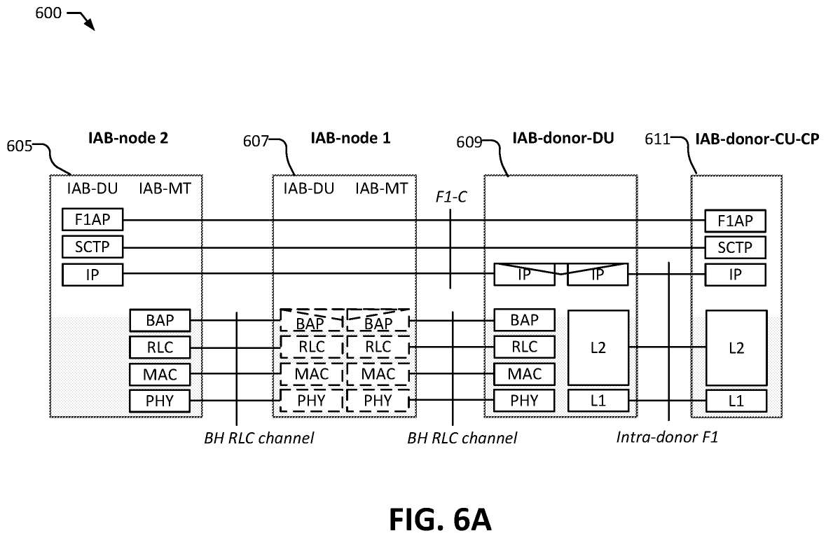

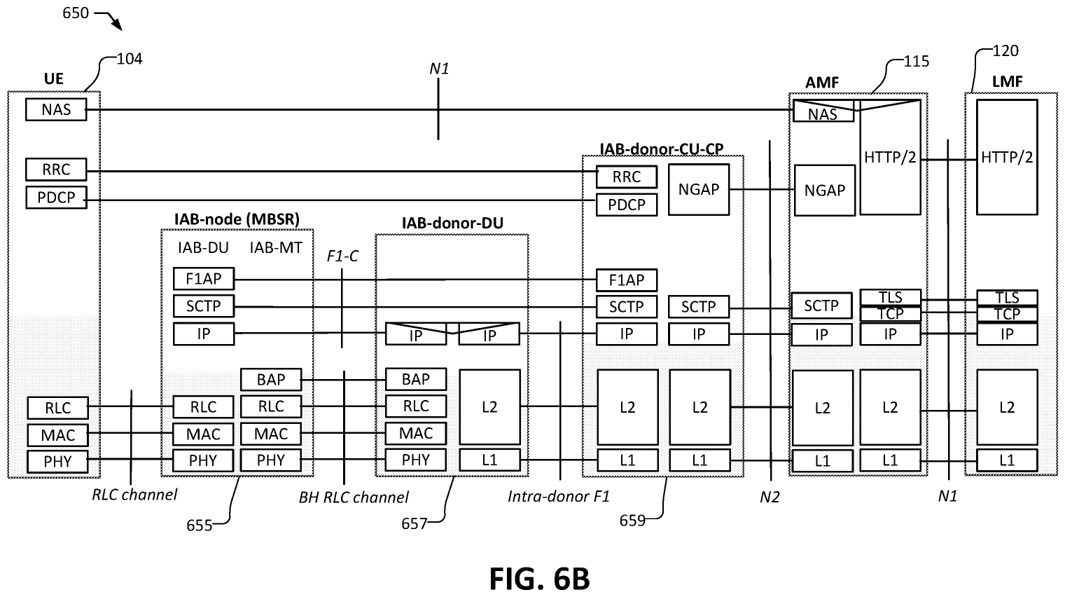

FIG. 6A is a diagram of a protocol stack 600 for F1-C between IAB-DU of IAB-node 2 605 (e.g. which may be an MBSR) and the IAB-donor-CU-CP 611 (e.g. which may be part of a gNB). In protocol stack 600, F1-C traffic is carried over two backhaul hops (one hop between IAB-node 2 605 and IAB-node 1 607 and the second hop between IAB-node 1 607 and IAB-donor DU 609). The F1 traffic may need to be security-protected.

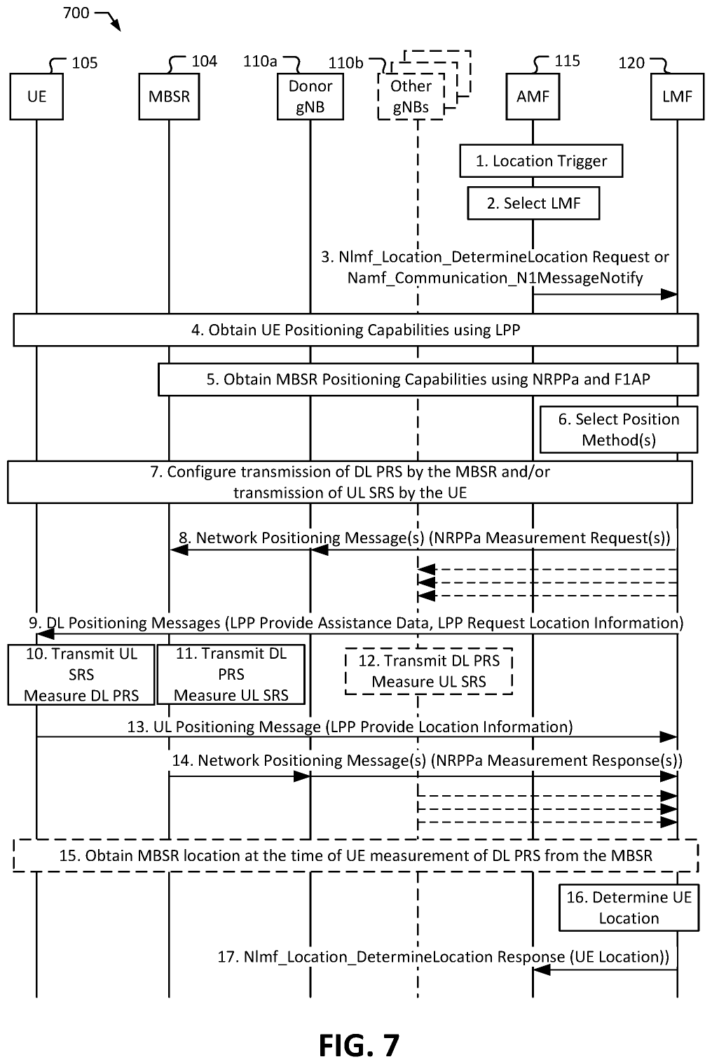

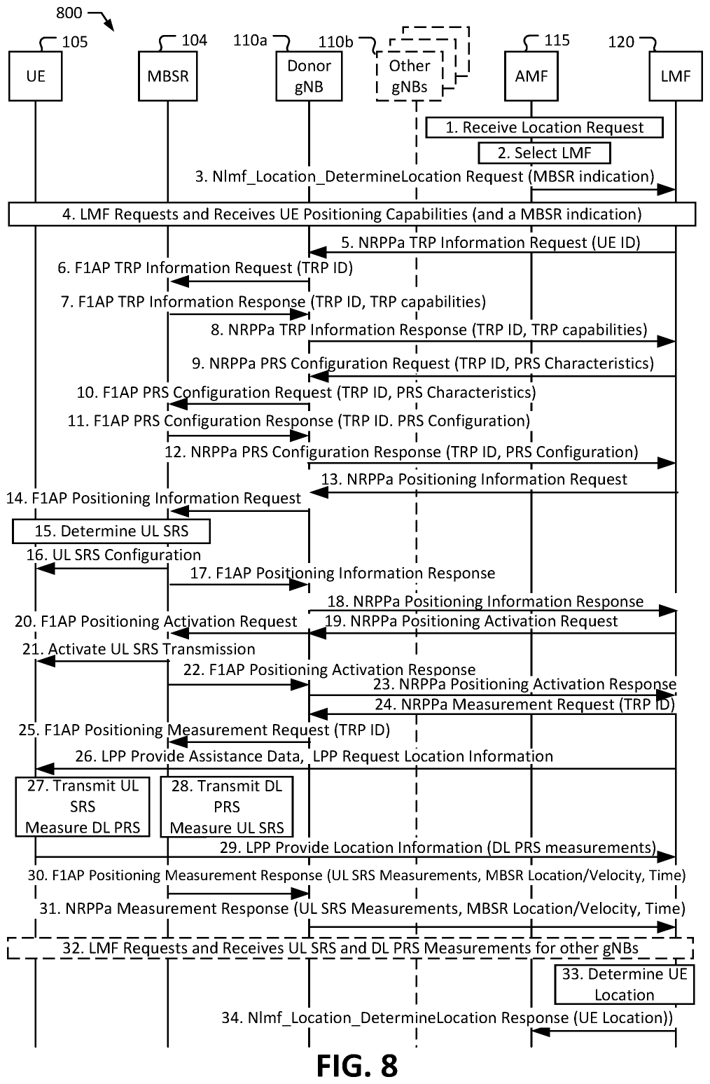

FIG. 6B is a diagram of a protocol stack 650 between a UE 105 and LMF 120, where the UE 105 has access to the LMF 120 via an MBSR 655, donor gNB 657/659 and serving AMF 115, showing F1-C between an IAB-DU of the IAB node (MBSR) 655, IAB-donor-DU 657 and the IAB-donor-CU-CP 659. The protocol stack 650, for example, may be used to transport positioning messages between the LMF 120 and the donor gNB 657/659, the MBSR 655 and/or the UE 105 during positioning of the UE 105 by the LMF 120, e.g. as described later for FIGS. 7 and 8.

FIG. 7, by way of example, is a signal flow 700 illustrating the signaling for positioning of a UE 105 connected to an LMF 120 via a MBSR 104, donor gNB 110a, and AMF 115. The signal flow 700 illustrates a generalized procedure to support positioning of a UE 105 accessing a MBSR 104 that is applicable to a 5GC-MT-LR (Mobile Terminated Location Request), 5GC-MO-LR (Mobile Originated Location Request), 5GC-NI-LR (Network Induced Location Request) and deferred 5GC-MT-LR. In FIG. 7, and in other figures discussed herein, operations may be referred to as numerical “stages.” Further, in some figures, operations may be labeled with their corresponding stage numbers.

At stage 1, a trigger for either locating the UE 105 or reporting a UE location event occurs at the AMF 115. The trigger can be a request for a 5GC-MT-LR received from a GMLC 125 (shown in FIG. 1), a request for a 5GC-MO-LR received from the UE 105, a trigger for a 5GC-NI-LR, or an event report sent by the UE 105 for a deferred 5GC-MT-LR for periodic or triggered location.

At stage 2, the AMF 115 selects an LMF 120. Except for a deferred 5GC-MT-LR for periodic or triggered location where the LMF 120 may be preassigned, the AMF 115 selects an LMF 120 and may select an LMF 120 able to support location for MBSR access if the AMF 115 is aware (e.g. from the donor gNB 110a) that the UE 105 has access via a MBSR 104.

At stage 3, for a 5GC-MT-LR, 5GC-MO-LR or 5GC-NI-LR, the AMF 115 sends a location request to the LMF 120 using a Nlmf_Location_DetermineLocation Request service operation and may include parameters such as serving cell ID, LCS Correlation identifier and required QoS. For a deferred 5GC-MT-LR for periodic or triggered location, the AMF 115 forwards the event report received from the UE 105 to the LMF 120. For both cases, the AMF 115 indicates MBSR access if the AMF 115 is aware of this.

At stage 4, the LMF 120 obtains the UE positioning capabilities using LPP. The UE 105, if aware, may indicate MBSR access to the LMF 120.

At stage 5, if MBSR access is indicated at either stage 3 or stage 4, the LMF 120 requests the positioning capabilities of the MBSR 104 when functioning as a TRP using an NRPPa procedure (TRP Information exchange) and a corresponding F1AP procedure, with the NRPPa TRP INFORMATION REQUEST message to the donor gNB 110a by the LMF 120 indicating that the request relates to the MBSR serving the target UE. This could be accomplished by sending the NRPPa TRP INFORMATION REQUEST message to the donor gNB 110a as a UE-associated message rather than as a non-UE-associated message. The MBSR 104 returns its positioning capabilities which indicate, for example, a capability to act as a TRP that can configure and transmit DL PRS to the UE 105 and configure and measure UL SRS transmitted by the UE 105. A TRP ID for the MBSR 104 is also assigned by the donor gNB 110a and returned to the LMF 120. The TRP ID allows the LMF 120 to indicate the MBSR 104 to the donor gNB 110a at stages 7, 8, and 15 and allows the MBSR 104 to identify itself at stage 14.

At stage 6, the LMF 120 selects one or more position methods supported by the UE 105 and the MBSR as indicated by the positioning capabilities received at stages 4 and 5. If position methods are selected that are not supported by the MBSR, the procedure here is no longer applicable and is not used.

At stage 7, depending on the position methods selected at stage 6, the LMF 120 may use existing procedures to configure transmission of DL PRS by the MBSR (and possibly from other nearby gNBs 110b) and/or configure transmission of UL SRS by the UE 105. These procedures make use of sending and receiving NRPPa messages to and from the donor gNB 110a.

At stage 8, if the LMF 120 configured transmission of UL SRS by the UE 105 at stage 7, the LMF 120 uses existing procedures to request measurements of the UL SRS by the MBSR 104 and optionally by other nearby gNBs 110b. The LMF 120 may exchange NRPPa messages with the donor gNB 110a (and other gNBs 110b) for this purpose.

At stage 9, if the LMF 120 configured transmission of DL PRS by the MBSR 104 at stage 7, the LMF 120 uses existing procedures to request measurements of the DL PRS by the UE 105 and optionally of DL PRS from other nearby gNBs 110b. The LMF 120 may exchange LPP messages with the UE 105 for this purpose.

At stage 10, the UE 105 transmits UL SRS if requested at stage 7 and/or measures DL PRS from the MBSR 104 (and other gNBs 110b) if requested at stage 9.

At stage 11, the MBSR 104 transmits DL PRS if requested at stage 7 and/or measures UL SRS from the UE 105 if requested at stage 8.

At stage 12, other gNBs 110b may transmit DL PRS if requested at stage 7 and/or measure UL SRS from the UE 105 if requested at stage 8.

At stage 13, if the UE 105 measured DL PRS from the MBSR 104 (and other gNBs 110b) at stage 10 as requested at stage 9, the UE 105 returns the measurements to the LMF 120 and includes the time (or times) of the measurements.

At stage 14, if the MBSR 104 (and other gNBs 110) measured UL SRS from the UE 105 at stage 11 (and stage 12) as requested at stage 8, the MBSR 104 (and other gNBs 110b) return the measurements to the LMF 120. The MBSR 104 also includes the MBSR location at the time of measurement and the MBSR velocity.

At stage 15, if the LMF 120 receives UE 105 measurements of DL PRS transmitted by the MBSR 104 at stage 13 along with a time of measurement, the LMF 120 may request the location of the MBSR 104 from the MBSR 104 for the time of measurement using a slightly modified NRPPa procedure for obtaining the location of a TRP. This may not be needed, however, if the MBSR 104 provides a location and velocity for the MBSR at stage 14 because the LMF 120 can then estimate the location of the MBSR 104 at the time of measurement using this location and velocity.

At stage 16, the LMF 120 determines the UE 105 location using the measurements received at stages 13 and/or 14. The LMF 120 also uses the location and velocity of the MBSR 104 received at stage 14 and/or the MBSR location received at stage 15 to determine the MBSR location(s) as input for the determination of the UE 105 location.

At stage 17, for a 5GC-MT-LR, 5GC-MO-LR, or 5GC-NI-LR, the LMF 120 returns the UE 105 location to the AMF 115. For a deferred 5GC-MT-LR for periodic or triggered location, the LMF 120 may forward the event report and the UE 105 location to a GMLC to send on to an LCS Client or AF.

FIG. 8, by way of example, is another signal flow 800 illustrating the signaling for positioning of a UE 105 connected to an LMF 120 via a MBSR 104, donor gNB 110a, and AMF 115. The signal flow 800, is similar to signal flow 700 shown in FIG. 7 but illustrates a more detailed procedure to support positioning of a UE 105 accessing a MBSR 104 that is applicable to a 5GC-MT-LR, 5GC-MO-LR, 5GC-NI-LR, and deferred 5GC-MT-LR.

At stage 1, a location request, e.g., location trigger, for the UE 105 is received by the AMF 115 for an NI-LR, MT-LR, or MO-LR.

At stage 2, the AMF 115 selects an LMF 120 and may select an LMF 120 able to support location with a MBSR 104.

At stage 3, the AMF 115 sends the location request to the LMF 120 and indicates to the LMF 120 that a MBSR 104 is used by the UE 105 (if known by the AMF 115) and includes the donor gNB 110a identity.

At stage 4, the LMF 120 requests and obtains UE positioning capabilities using LPP. The UE 105 may indicate in the response that relaying is being used (e.g. by a MBSR 104).

At stage 5, based on the MBSR 104 indication, the LMF 120 sends a request to the donor gNB 110a for a TRP ID and TRP capabilities of the MBSR 104. The request can be an NRPPa TRP Information Request that indicates a request for MBSR TRP information in one of various ways.

In one implementation, referred to as Solution 1a, normally, an NRPPa TRP Information Request is sent to a gNB by the LMF 120 using non-UE associated transport in which the NRPPa TRP Information Request first sent to an AMF 115 in a Namf_Communication_NonUeN2MessageTransfer service operation which then causes the AMF 115 to forward the NRPPa message to the gNB in an NGAP DOWNLINK NON UE ASSOCIATED NRPPA TRANSPORT message. With the present implementation, the NRPPa TRP Information Request is sent to the donor gNB 110a by the LMF 120 using UE-associated transport (with association with the target UE 105) in which the LMF 120 first sends the NRPPa TRP Information Request to the serving AMF 115 in an Namf_Communication_N1N2MessageTransfer service operation (associated with the target UE 105) which causes the serving AMF 115 to forward the NRPPa message to the donor gNB 110a in an NGAP DOWNLINK UE ASSOCIATED NRPPA TRANSPORT message. The LMF 120 also does not include any TRP ID(s) in the NRPPa TRP Information Request. The donor gNB 110a can infer from the use of UE-associated transport (with association with the target UE 105), the lack of a TRP ID, and the use by the target UE 105 of a MBSR 104 that the NRPPa TRP Information Request is a request for information about TRP(s) supported by the MBSR 104.

In a variant of Solution 1a, referred to as Solution 1b the UE-associated transport with association with the target UE 105 in the previous implementation is replaced by UE-associated transport with association with the UE portion of the MBSR 104. At stage 3, the AMF 115 also provides a correlation ID to the LMF 120 for the UE portion of the MBSR 104 and an indication that this is for a MBSR 104. The previous implementation may then be performed but with the transport associated with the UE portion of the MBSR 104.

In another implementation, referred to as Solution 2a, the LMF 120 sends the NRPPa TRP Information Request to the donor gNB 110a μsing non-UE associated transport as normal. However, the LMF 120 does not include any TRP ID(s) in the NRPPa TRP Information Request and instead includes an indication of the target UE 105. The indication can be an NGAP ID previously assigned by the donor gNB 110a for the target UE 105 which is known to the serving AMF 115 and provided to the LMF 120 at stage 3. Based on the UE 105 indication, the lack of any TRP ID(s) in the NRPPa TRP Information Request and knowledge that the target UE 105 is using a MBSR, the donor gNB 110a can infer that the NRPPa TRP Information Request is a request for information about TRP(s) supported by the MBSR 104.

In a variant of the Solution 2a, referred to as Solution 2b, the indication of the target UE 105 in the previous implementation is replaced by a similar indication of the UE portion of the MBSR 104 which the AMF 115 can provide to the LMF 120 at stage 3.

At stage 6, based on the inference described for Solution 1a/1b or Solution 2a/2b in stage 5, the donor gNB 110a forwards the request for TRP capabilities of the MBSR 104 to the MBSR 104 as an F1AP TRP Information Request. The donor gNB 110a also assigns a TRP ID to the MBSR 104 (not assigned to any other TRP) and includes the MBSR TRP ID in the F1AP TRP Information Request.

At stage 7, the MBSR 104 returns an F1AP TRP Information Response to the donor gNB 110a and includes the positioning capabilities of the MBSR 104 and the MBSR TRP ID. The positioning capabilities indicate that the MBSR 104 can function as a TRP and can support on-demand DL PRS and include the on-demand DL PRS parameters supported by the MBSR 104.

At stage 8, the donor gNB 110a returns the MBSR TRP ID and positioning capabilities of the MBSR 104 to the LMF 120 via the serving AMF 115 in an NRPPa TRP Information Response. This is transported to the LMF 120 using UE 105-associated signaling if Solution 1a/1b is used or using non-UE-associated signaling if Solution 2a/2b is used.

At stage 9, based on the indications that the MBSR 104 can function as a TRP and can support on-demand DL PRS, the LMF 120 determines transmission characteristics of DL PRS to be transmitted by the MBSR 104 (e.g. PRS bandwidth, frequency layers, comb size, periodicity, start time, duration). The determined transmission characteristics of DL PRS are made compatible with the on-demand DL PRS parameters supported by the MBSR 104 received at stage 8. The LMF 120 sends a request for on-demand DLR PRS with the transmission characteristics of the DL PRS to the donor gNB 110a and includes the MBSR TRP ID in an NRPPa PRS Configuration Request which is sent to the donor gNB 110a via the serving AMF 115 using UE associated signaling.

At stage 10, based on receiving the MBSR TRP ID at stage 9, the gNB forwards the request for on-demand DLR PRS with the transmission characteristics of the DL PRS to the MBSR 104 in an FLAP PRS Configuration Request.

At stage 11, the MBSR 104 confirms the request for on-demand DL PRS by returning an F1AP PRS Configuration Response to the donor gNB 110a.

At stage 12, the donor gNB 110a returns the confirmation of the request for on-demand DL PRS in an NRPPa PRS Configuration Response to the LMF 120.

At stage 13, the LMF 120 requests UL SRS transmission from the target UE 105 by sending an NRPPa Positioning Information Request to the donor gNB 110a CU and includes transmission characteristics of the UL SRS such as bandwidth, type (e.g. periodic, aperiodic semi-persistent) and periodicity. The message is sent to the donor gNB 110a μsing (target) UE associated signaling.

At stage 14, as the UE 105 is accessing donor gNB 110a via the MBSR 104, the donor gNB 110a forwards the requests UL SRS transmission and the transmission characteristics of the UL SRS to the MBSR 104 in an F1AP Positioning Information Request.

At stage 15, the MBSR 104 determines an UL SRS configuration based on the received transmission characteristics of UL SRS received at stage 14.

At stage 16, the MBSR 104 sends the determined UL SRS configuration to the UE 105.

At stage 17, the MBSR 104 confirms the UL SRS by returning an F1AP Positioning Information Response to the donor gNB 110a and includes the UL SRS configuration determined at stage 15.

At stage 18, the donor gNB 110a returns the confirmation and the UL SRS configuration to the LMF 120 in an NRPPa Positioning Information Response.

At stage 19, for aperiodic or semi-persistent UL SRS, the LMF 120 sends an NRPPa Positioning Activation Request to the donor gNB 110a μsing UE 105 associated signaling to activate UL SRS transmission by the UE 105.

At stage 20, the donor gNB 110a forwards the activation request to the MBSR 104 in an F1AP Positioning Activation Request.

At stage 21, the MBSR 104 sends a request to the UE 105 to a start UL SRS transmission.

At stage 22, the MBSR 104 returns a confirmation of the UL SRS activation to the donor gNB 110a in an FLAP Positioning Activation Response.

At stage 23, the donor gNB 110a returns the confirmation to the LMF 120 in an NRPPa Positioning Activation Response. Stages 19-23 may be performed after stages 24 and 25 and/or after stage 26 in some implementations.

At stages 24-25, the LMF 120 requests RTT Rx-Tx measurements and possibly AOA measurements by the MBSR 104 of the UL SRS transmitted by the UE 105.

At stage 26, the LMF 120 may send a Provide Assistance Data message with positioning assistance data for the UE 105 and requests RTT Rx-Tx measurements by the target UE 105 of the MBSR 104 DL PRS using LPP, e.g., in an LPP Request Location Information message. The Provide Assistance Data message and LPP Request Location Information message may be transmitted as separate messages.

At stage 27, the UE 105 measures the DL PRS from the MBSR 104 and transmits the UL SRS to the MBSR 104.

At stage 28, the MBSR 104 measures the UL SRS from the UE 105 and transmits the DL PRS towards the UE 105.

At stage 29, the UE 105 sends the Rx-Tx measurements to the LMF 120.

At stages 30-31, the MBSR 104 sends the Rx-Tx (and possibly AOA) measurement(s) of the UL SRS to the LMF 120 via the donor gNB 110a μsing F1AP (to the donor gNB 110a CU) and then NRPPa to the LMF 120. The MBSR 104 also includes the MBSR 104 location and possibly velocity at the time of UL SRS measurement, which may be based on satellite positioning if the MBSR 104 has GNSS capability. The MBSR 104 might also include a short location history. The LMF 120 might also or instead request earlier/later locations (e.g. a location history) from the MBSR 104 (using NRPPa).

At stage 32, the LMF 120 may request other gNBs to measure the UE UL SRS and the UE 105 to measure DL PRS from the other gNBs.

At stage 33, the LMF 120 determines a UE 105 location from the measurements received at stages 29 and 31. The LMF 120 uses the MBSR 104 location (location 1) at the time T1 of measurement of the UL SRS by the MBSR 104 to help determine the UE 105 location. The LMF 120 also uses the MBSR 104 location and velocity information to determine the MBSR 104 location (location 2) at the time T2 of UE 105 measurement of MBSR 104 DL PRS and may compensate for any difference between location 1 and location 2 when the MBSR 104 is moving and time T1 differs from time T2.

At stage 34, the LMF 120 returns the UE 105 location to the AMF 115.

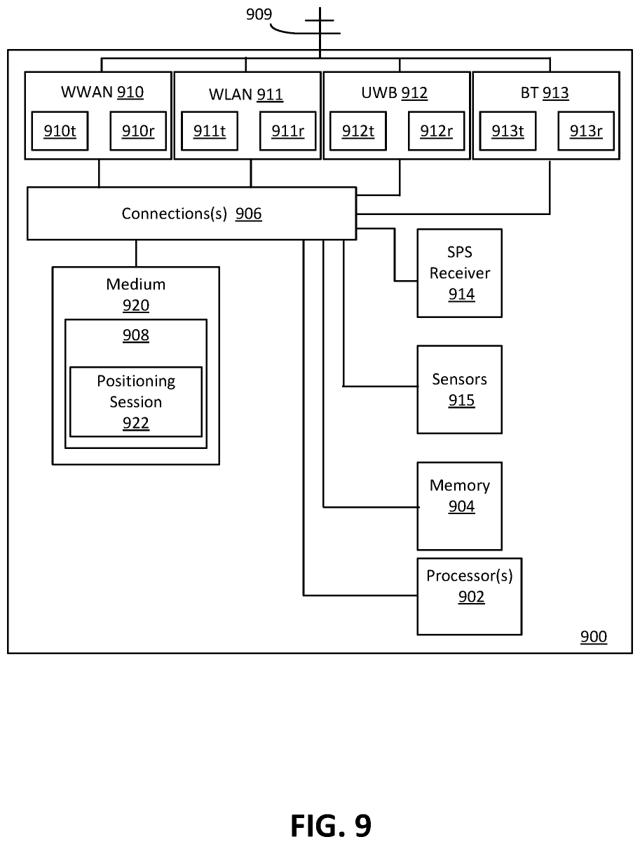

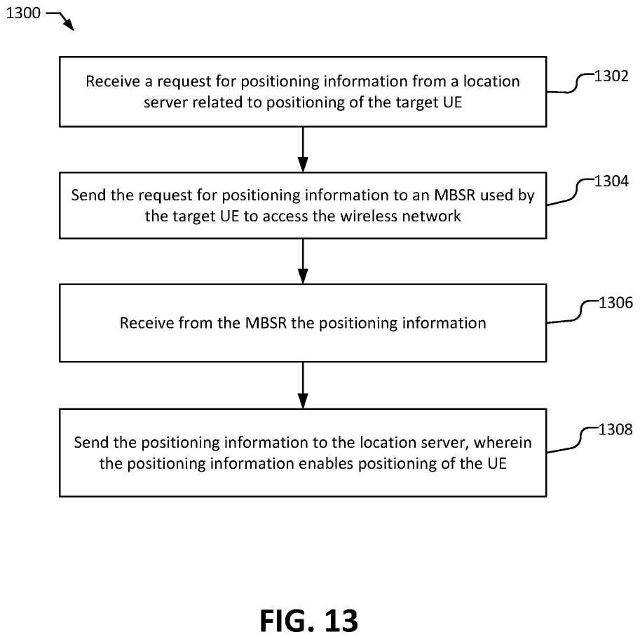

FIG. 9 shows a schematic block diagram illustrating certain exemplary features of a MBSR 900, e.g., which may be the MBSR 104 shown in FIGS. 1, 4, 7, and 8, and any of the MBSRs or IAB nodes illustrated in FIGS. 3, 5, 6A, and 6B, and supports positioning of a UE, as described herein. The MBSR 900, for example, may be configured to perform the signal flows 700 and 800 shown in respective FIGS. 7 and 8 and the process flow 1300, shown in FIG. 13, and accompanying techniques as discussed herein. The MBSR 900 may include the architecture and function elements and other layers for communication as described in FIGS. 5, 6A, and 6B.

The MBSR 900 may include, for example, one or more processors 902, memory 904, an external interface such as at least one wireless transceiver (e.g., wireless network interface) illustrated as WWAN transceiver 910, WLAN transceiver 911, an Ultra-Wideband (UWB) transceiver 912 and a Bluetooth (BT) transceiver 913, SPS receiver 914, and one or more sensors 915, which may be operatively coupled with one or more connections 906 (e.g., buses, lines, fibers, links, etc.) to non-transitory computer-readable medium 920 and memory 904. The SPS receiver 914, for example, may receive and process SPS signals from satellite vehicles 190 shown in FIG. 1 for determining a location and optionally a velocity of the MBSR 900. The one or more sensors 915, for example, may be an inertial measurement unit (IMU) that may include one or more accelerometers, one or more gyroscopes, a magnetometer, etc. The MBSR 900 may further include additional items, which are not shown, such as a user interface that may include e.g., a display, a keypad, or other input device, such as a virtual keypad on the display, through which a user may interface with the UE. In certain example implementations, all or part of MBSR 900 may take the form of a chipset, and/or the like.

The MBSR 900 may include at least one wireless transceiver, such as wireless transceiver 910 for a WWAN communication system and wireless transceiver 911 for a WLAN communication system, UWB transceiver 912 for a UWB communication system, BT transceiver 913 for a Bluetooth communication system, or a combined transceiver for any of WWAN, WLAN, UWB, and BT. The WWAN transceiver 910 may include a transmitter 910t and receiver 910r coupled to one or more antennas 909 for transmitting and/or receiving wireless signals and transducing signals from the wireless signals to wired (e.g., electrical and/or optical) signals and from wired (e.g., electrical and/or optical) signals to the wireless signals. The WLAN transceiver 911 may include a transmitter 911t and receiver 911r coupled to one or more antennas 909, or to separate antennas, for transmitting and/or receiving wireless signals and transducing signals from the wireless signals to wired (e.g., electrical and/or optical) signals and from wired (e.g., electrical and/or optical) signals to the wireless signals. The UWB transceiver 912 may include a transmitter 912t and receiver 912r coupled to one or more antennas 909, or to separate antennas, for transmitting and/or receiving wireless signals and transducing signals from the wireless signals to wired (e.g., electrical and/or optical) signals and from wired (e.g., electrical and/or optical) signals to the wireless signals. The BT transceiver 913 may include a transmitter 913t and receiver 913r coupled to one or more antennas 909, or to separate antennas, for transmitting and/or receiving wireless signals and transducing signals from the wireless signals to wired (e.g., electrical and/or optical) signals and from wired (e.g., electrical and/or optical) signals to the wireless signals. The transmitters 910t, 911t, 912t, and 913t may include multiple transmitters that may be discrete components or combined/integrated components, and/or the receivers 910r, 911r, 912r, and 913r may include multiple receivers that may be discrete components or combined/integrated components. The WWAN transceiver 910 may be configured to communicate signals (e.g., with UEs and donor base stations) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), etc. New Radio may use mm-wave frequencies and/or sub-6 GHz frequencies. The WLAN transceiver 911 may be configured to communicate signals (e.g., with access points and/or one or more other devices) according to a variety of radio access technologies (RATs) such as 3GPP LTE-V2X (PC5), IEEE 1102.11 (including IEEE 1102.11p), WiFi, WiFi Direct (WiFi-D), Zigbee, etc. The UWB transceiver 912 may be configured to communicate signals (e.g., with access points and/or one or more other devices) according to a variety of radio access technologies (RATs) such as personal area network (PAN) including IEEE 802.15.3, IEEE 802.15.4, etc. The BT transceiver 913 may be configured to communicate signals (e.g., with access points and/or one or more other devices) according to a variety of radio access technologies (RATs) such as a Bluetooth network. The transceivers 910, 911, 912, and 913 may be communicatively coupled to a transceiver interface, e.g., by optical and/or electrical connection, which may be at least partially integrated with the transceivers 910, 911, 912, 913.

In some embodiments, MBSR 900 may include antenna 909, which may be internal or external. UE antenna 909 may be used to transmit and/or receive signals processed by wireless transceivers 910, 911, 912, and 913. In some embodiments, UE antenna 909 may be coupled to wireless transceivers 910, 911, 912, and 913. In some embodiments, measurements of signals received (transmitted) by MBSR 900 may be performed at the point of connection of the UE antenna 909 and wireless transceivers 910, 911, 912, and 913. For example, the measurement point of reference for received (transmitted) RF signal measurements may be an input (output) UE of the receiver 910r (transmitter 910t) and an output (input) UE of the UE antenna 909. In a MBSR 900 with multiple UE antennas 909 or antenna arrays, the antenna connector may be viewed as a virtual point representing the aggregate output (input) of multiple UE antennas. In some embodiments, MBSR 900 may measure received signals including signal strength and TOA measurements and the raw measurements may be processed by the one or more processors 1002, such as AOA, RSRP, Rx-TX, TOA, etc., of UL SRS signals from a target UE 105.

The one or more processors 902 may be implemented using a combination of hardware, firmware, and software. For example, the one or more processors 902 may be configured to function as a gNB Transmission-Reception Point (TRP), e.g., with an ability to transmit DLR PRS to a target UE and measure UL SRS transmitted by the target UE. The MBSR may include an ability to support on demand transmission or PRS that may be time aligned/synchronized with PRS transmission from a donor gNB. The one or more processors 902 may be configured so that the MBSR functions as an Integrated Access and Backhaul (IAB) node, accessing the wireless network as a UE via a donor gNB, and also supporting a gNB Distributed Unit (DU) capability, which allows a target UE to view the MBSR as a gNB and to access the 5G Network via the MBSR (and the donor gNB). The one or more processors 902 may be configured to perform the functions discussed herein by implementing one or more instructions or program code 908 on a non-transitory computer readable medium, such as medium 920 and/or memory 904. In some embodiments, the one or more processors 902 may represent one or more circuits configurable to perform at least a portion of a data signal computing procedure or process related to the operation of MBSR 900.

The medium 920 and/or memory 904 may store instructions or program code 908 that contain executable code or software instructions that when executed by the one or more processors 902 cause the one or more processors 902 to operate as a special purpose computer programmed to perform the techniques disclosed herein. As illustrated in MBSR 900, the medium 920 and/or memory 904 may include one or more components or modules that may be implemented by the one or more processors 902 to perform the methodologies described herein. While the components or modules are illustrated as software in medium 920 that is executable by the one or more processors 902, it should be understood that the components or modules may be stored in memory 904 or may be dedicated hardware either in the one or more processors 902 or off the processors.

A number of software modules and data tables may reside in the medium 920 and/or memory 904 and be utilized by the one or more processors 902 in order to manage both communications and the functionality described herein. It should be appreciated that the organization of the contents of the medium 920 and/or memory 904 as shown in MBSR 900 is merely exemplary, and as such the functionality of the modules and/or data structures may be combined, separated, and/or be structured in different ways depending upon the implementation of the MBSR 900. The medium 920 and/or memory 904, for example, may include a positioning module 922 that when implemented by the one or more processors 902 configures the one or more processors 902 to perform a positioning session with a target UE that accesses a wireless network through the MBSR 900, e.g., as illustrated in FIGS. 7 and 8.

The methodologies described herein may be implemented by various means depending upon the application. For example, these methodologies may be implemented in hardware, firmware, software, or any combination thereof. For a hardware implementation, the one or more processors 902 may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a non-transitory computer-readable medium 920 or memory 904 that is connected to and executed by the one or more processors 902. Memory may be implemented within the one or more processors or external to the one or more processors. As used herein the term “memory” refers to any type of long-term, short-term, volatile, nonvolatile, or other memory and is not to be limited to any particular type of memory or number of memories, or type of media upon which memory is stored.

If implemented in firmware and/or software, the functions may be stored as one or more instructions or program code 908 on a non-transitory computer-readable medium, such as medium 920 and/or memory 904. Examples include computer-readable media encoded with a data structure and computer-readable media encoded with a computer program code 908. For example, the non-transitory computer-readable medium including program code 908 stored thereon may include program code 908 to support positioning of a target UE in a manner consistent with disclosed embodiments. Non-transitory computer-readable medium 920 includes physical computer storage media. A storage medium may be any available medium that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to store desired program code 908 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium 920, instructions and/or data may be provided as signals on transmission media included in a communication apparatus. For example, a communication apparatus may include an external interface including one or more of wireless transceivers 910, 911, 912, and 913 having signals indicative of instructions and data. The instructions and data are configured to cause one or more processors to implement the functions outlined in the claims. That is, the communication apparatus includes transmission media with signals indicative of information to perform disclosed functions.

Memory 904 may represent any data storage mechanism. Memory 904 may include, for example, a primary memory and/or a secondary memory. Primary memory may include, for example, a random access memory, read-only memory, etc. While illustrated in this example as being separate from one or more processors 902, it should be understood that all or part of a primary memory may be provided within or otherwise co-located/coupled with the one or more processors 902. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer-readable medium 920. As such, in certain example implementations, the methods and/or apparatuses presented herein may take the form in whole or part of a computer-readable medium 920 that may include computer implementable program code 908 stored thereon, which if executed by one or more processors 902 may be operatively enabled to perform all or portions of the example operations as described herein. Computer-readable medium 920 may be a part of memory 904.

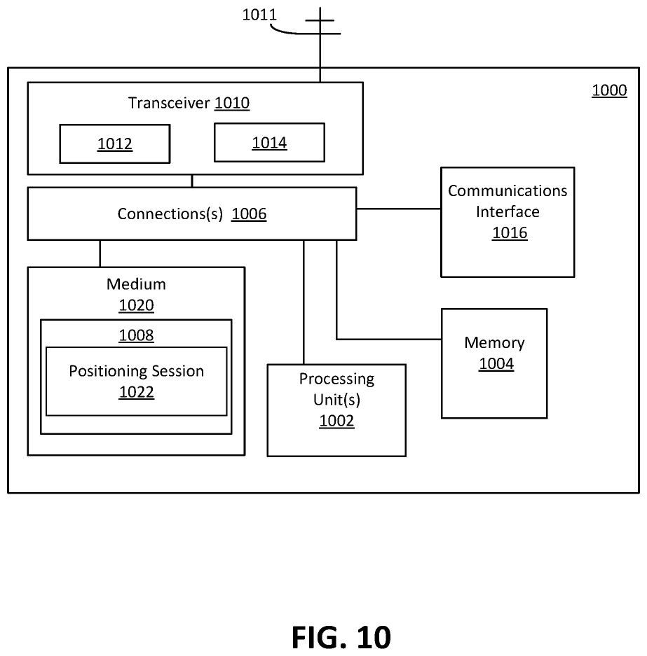

FIG. 10 shows a schematic block diagram illustrating certain exemplary features of a base station 1000, e.g., which may be eNB, gNB or donor gNB 110 shown in FIGS. 1, 4, 7, and 8, and any of the base stations and donor gNBs illustrated in FIGS. 2, 3, 5, 6A, and 6b. The base station 1000 may be a donor base station that supports a MBSR and is configured to support positioning of a target UE accessing a wireless network via a MBSR as described herein. The base station 1000, for example, may be configured to perform the signal flows 700 and 800 shown in respective FIGS. 7 and 8 and the process flow 1300, shown in FIG. 13, and accompanying techniques as discussed herein. The base station 1000 may include the architecture and function elements and other layers for communication as described in FIGS. 5, 6A, and 6B.

Base station 1000 may, for example, include one or more processors 1002, memory 1004, an external interface, which may include a wireless transceiver 1010 (e.g., wireless network interface) and a communications interface 1016 (e.g., wireline or wireless network interface to other base stations and/or entities in the core network such as the LMF 120 or SLP 119 via the AMF 115 or UPF 118 for communication with an external client 130), which may be operatively coupled with one or more connections 1006 (e.g., buses, lines, fibers, links, etc.) to non-transitory computer readable medium 1020 and memory 1004. The base station 1000 may further include additional items, which are not shown, such as a user interface that may include e.g., a display, a keypad or other input device, such as virtual keypad on the display, through which a user may interface with the base station. In certain example implementations, all or part of base station 1000 may take the form of a chipset, and/or the like. Transceiver 1010 may, for example, include a transmitter 1012 enabled to transmit one or more signals over one or more types of wireless communication networks and a receiver 1014 to receive one or more signals transmitted over the one or more types of wireless communication networks. The communications interface 1016 may be a wired or wireless interface capable of connecting to other base stations in the RAN or network entities, such as a location server, e.g., LMF 120 or SLP 119 shown in FIG. 1.

In some embodiments, base station 1000 may include antenna 1011, which may be internal or external. Antenna 1011 may be used to transmit and/or receive signals processed by transceiver 1010. In some embodiments, antenna 1011 may be coupled to transceiver 1010. In some embodiments, measurements of signals received (transmitted) by base station 1000 may be performed at the point of connection of the antenna 1011 and transceiver 1010. For example, the measurement point of reference for received (transmitted) RF signal measurements may be an input (output) terminal of the receiver 1014 (transmitter 1012) and an output (input) terminal of the antenna 1011. In a base station 1000 with multiple antennas 1011 or antenna arrays, the antenna connector may be viewed as a virtual point representing the aggregate output (input) of multiple antennas. In some embodiments, base station 1000 may measure received signals including signal strength and TOA measurements and the raw measurements may be processed by the one or more processors 1002, such as AOA, RSRP, Rx-TX, TOA, etc., of UL SRS signals from a target UE 105.

The one or more processors 1002 may be implemented using a combination of hardware, firmware, and software. For example, the one or more processors 1002 may be configured to perform the functions discussed herein by implementing one or more instructions or program code 1008 on a non-transitory computer-readable medium, such as medium 1020 and/or memory 1004. In some embodiments, the one or more processors 1002 may represent one or more circuits configurable to perform at least a portion of a data signal computing procedure or process related to the operation of base station 1000.

The medium 1020 and/or memory 1004 may store instructions or program code 1008 that contain executable code or software instructions that when executed by the one or more processors 1002 cause the one or more processors 1002 to operate as a special purpose computer programmed to perform the techniques disclosed herein. As illustrated in base station 1000, the medium 1020 and/or memory 1004 may include one or more components or modules that may be implemented by the one or more processors 1002 to perform the methodologies described herein. While the components or modules are illustrated as software in medium 1020 that is executable by the one or more processors 1002, it should be understood that the components or modules may be stored in memory 1004 or may be dedicated hardware either in the one or more processors 1002 or off the processors.

A number of software modules and data tables may reside in the medium 1020 and/or memory 1004 and be utilized by the one or more processors 1002 in order to manage both communications and the functionality described herein. It should be appreciated that the organization of the contents of the medium 1020 and/or memory 1004 as shown in base station 1000 is merely exemplary, and as such the functionality of the modules and/or data structures may be combined, separated, and/or be structured in different ways depending upon the implementation of the base station 1000. The medium 1020 and/or memory 1004, for example, may include a positioning module 1022 that when implemented by the one or more processors 1002 configures the one or more processors 1002 to perform a positioning session with a target UE that accesses a wireless network through a MBSR, e.g., as illustrated in FIGS. 7 and 8.

The methodologies described herein may be implemented by various means depending upon the application. For example, these methodologies may be implemented in hardware, firmware, software, or any combination thereof. For a hardware implementation, the one or more processors 1002 may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a non-transitory computer-readable medium 1020 or memory 1004 that is connected to and executed by the one or more processors 1002. Memory may be implemented within the one or more processors or external to the one or more processors. As used herein the term “memory” refers to any type of long-term, short-term, volatile, nonvolatile, or other memory and is not to be limited to any particular type of memory or number of memories, or type of media upon which memory is stored.

If implemented in firmware and/or software, the functions may be stored as one or more instructions or program code 1008 on a non-transitory computer-readable medium, such as medium 1020 and/or memory 1004. Examples include computer-readable media encoded with a data structure and computer-readable media encoded with a computer program code 1008. For example, the non-transitory computer-readable medium including program code 1008 stored thereon may include program code 1008 to support positioning of a target UE in a manner consistent with disclosed embodiments. Non-transitory computer-readable medium 1020 includes physical computer storage media. A storage medium may be any available medium that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to store desired program code 1008 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 1020, instructions and/or data may be provided as signals on transmission media included in a communication apparatus. For example, a communication apparatus may include a transceiver 1010 having signals indicative of instructions and data. The instructions and data are configured to cause one or more processors to implement the functions outlined in the claims. That is, the communication apparatus includes transmission media with signals indicative of information to perform disclosed functions.

Memory 1004 may represent any data storage mechanism. Memory 1004 may include, for example, a primary memory and/or a secondary memory. Primary memory may include, for example, a random access memory, read-only memory, etc. While illustrated in this example as being separate from one or more processors 1002, it should be understood that all or part of a primary memory may be provided within or otherwise co-located/coupled with the one or more processors 1002. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer-readable medium 1020. As such, in certain example implementations, the methods and/or apparatuses presented herein may take the form in whole or part of a computer-readable medium 1020 that may include computer implementable program code 1008 stored thereon, which if executed by one or more processors 1002 may be operatively enabled to perform all or portions of the example operations as described herein. Computer-readable medium 1020 may be a part of memory 1004.

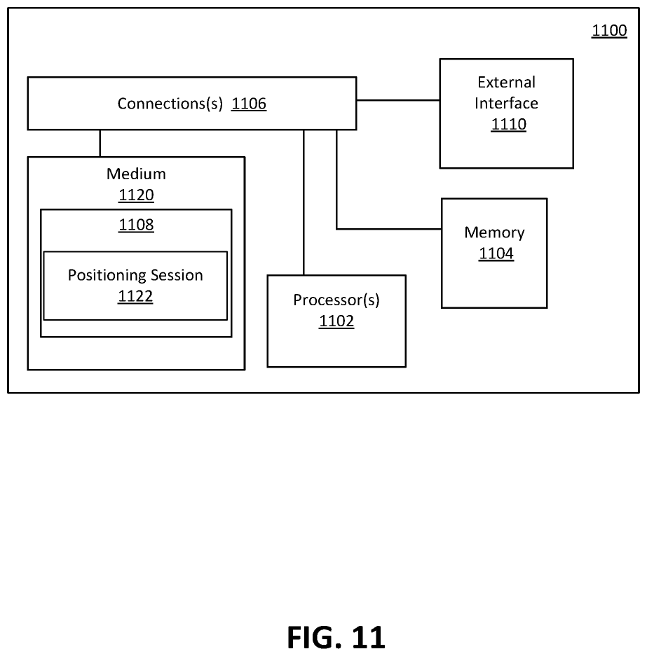

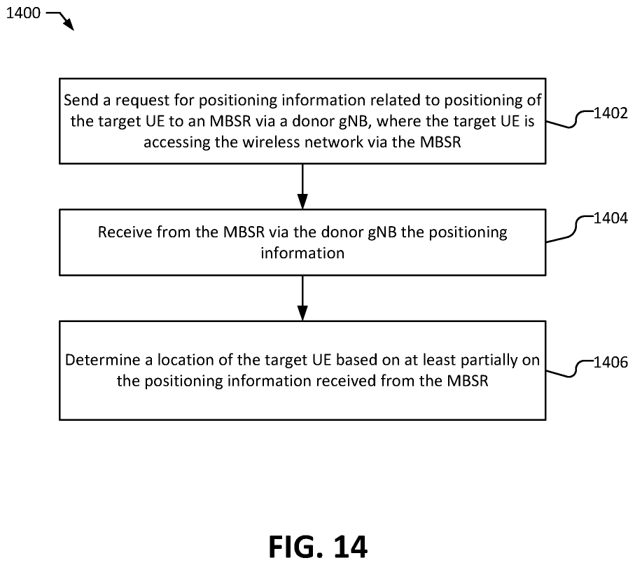

FIG. 11 shows a schematic block diagram illustrating certain exemplary features of a location server 1100, e.g., which may be LMF 120 shown in FIGS. 1, 6B, 7, and 8. The location server 1100 is configured to support positioning of a target UE accessing a wireless network via a MBSR, e.g., as discussed herein. The location server 1100, for example, may be configured to perform the signal flows 700 and 800 shown in respective FIGS. 7 and 8 and the process flow 1400, shown in FIG. 14, and accompanying techniques as discussed herein. The location server 1100 may include the architecture and function elements and other layers for communication as described in FIG. 6B.

The location server 1100 may, for example, include one or more processors 1102, memory 1104, an external interface 1110 (e.g., wireline or wireless network interface to base stations, MBSR, UEs, and/or entities in the core network), which may be operatively coupled with one or more connections 1106 (e.g., buses, lines, fibers, links, etc.) to non-transitory computer-readable medium 1120 and memory 1104. In certain example implementations, all or part of location server 1100 may take the form of a chipset, and/or the like. Depending on the implementation, the location server 1100 may include additional components not illustrated herein.

The one or more processors 1102 may be implemented using a combination of hardware, firmware, and software. For example, the one or more processors 1102 may be configured to perform the functions discussed herein by implementing one or more instructions or program code 1108 on a non-transitory computer-readable medium, such as medium 1120 and/or memory 1104. In some embodiments, the one or more processors 1102 may represent one or more circuits configurable to perform at least a portion of a data signal computing procedure or process related to the operation of location server 1100.

The medium 1120 and/or memory 1104 may store instructions or program code 1108 that contain executable code or software instructions that when executed by the one or more processors 1102 cause the one or more processors 1102 to operate as a special purpose computer programmed to perform the techniques disclosed herein. As illustrated in location server 1100, the medium 1120 and/or memory 1104 may include one or more components or modules that may be implemented by the one or more processors 1102 to perform the methodologies described herein. While the components or modules are illustrated as software in medium 1120 that is executable by the one or more processors 1102, it should be understood that the components or modules may be stored in memory 1104 or may be dedicated hardware either in the one or more processors 1102 or off the processors.

A number of software modules and data tables may reside in the medium 1120 and/or memory 1104 and be utilized by the one or more processors 1102 in order to manage both communications and the functionality described herein. It should be appreciated that the organization of the contents of the medium 1120 and/or memory 1104 as shown in location server 1100 is merely exemplary, and as such the functionality of the modules and/or data structures may be combined, separated, and/or be structured in different ways depending upon the implementation of the location server 1100. The medium 1020 and/or memory 1104, for example, may include a positioning module 1122 that when implemented by the one or more processors 1102 configures the one or more processors 1102 to perform a positioning session with a target UE that accesses a wireless network through a MBSR, e.g., as illustrated in FIGS. 7 and 8.

The methodologies described herein may be implemented by various means depending upon the application. For example, these methodologies may be implemented in hardware, firmware, software, or any combination thereof. For a hardware implementation, the one or more processors 1102 may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a non-transitory computer readable medium 1120 or memory 1104 that is connected to and executed by the one or more processors 1102. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 1108 on a non-transitory computer readable medium, such as medium 1120 and/or memory 1104. Examples include computer readable media encoded with a data structure and computer readable media encoded with a computer program code 1108. For example, the non-transitory computer readable medium including program code 1108 stored thereon may include program code 1108 to support positioning of a target UE in a manner consistent with disclosed embodiments. Non-transitory computer readable medium 1120 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 1108 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 1120, instructions and/or data may be provided as signals on transmission media included in a communication apparatus. For example, a communication apparatus may include an external interface 1110 having signals indicative of instructions and data. The instructions and data are configured to cause one or more processors to implement the functions outlined in the claims. That is, the communication apparatus includes transmission media with signals indicative of information to perform disclosed functions.

Memory 1104 may represent any data storage mechanism. Memory 1104 may include, for example, a primary memory and/or a secondary memory. Primary memory may include, for example, a random access memory, read only memory, etc. While illustrated in this example as being separate from one or more processors 1102, it should be understood that all or part of a primary memory may be provided within or otherwise co-located/coupled with the one or more processors 1102. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 1120. As such, in certain example implementations, the methods and/or apparatuses presented herein may take the form in whole or part of a computer readable medium 1120 that may include computer implementable program code 1108 stored thereon, which if executed by one or more processors 1102 may be operatively enabled to perform all or portions of the example operations as described herein. Computer readable medium 1120 may be a part of memory 1104.

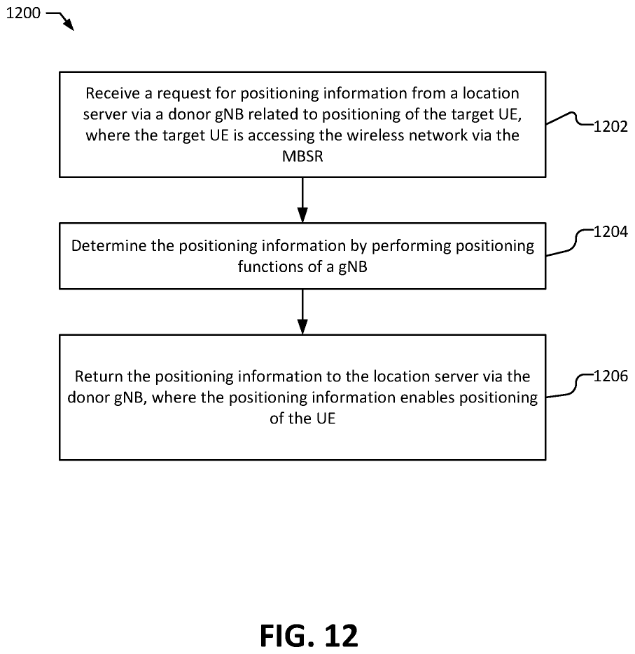

FIG. 12 shows a flowchart for an exemplary method 1200 for positioning of a target UE (e.g. a UE 105), performed by a MBSR in a wireless network, such as MBSR 104 shown in shown in FIG. 1 or MBSR 900 shown in FIG. 9, in a manner consistent with disclosed implementations.

At block 1202, the MBSR receives a request for positioning information from a location server (e.g. an LMF 120) via a donor gNB (e.g. a gNB 110) related to positioning of the target UE, where the target UE is accessing the wireless network via the MBSR, e.g., as discussed in stage 8 of FIG. 7 and stages 6, 10, 14 and 25 of FIG. 8. A means for receiving a request for positioning information from a location server via a donor gNB related to positioning of the target UE, where the target UE is accessing the wireless network via the MBSR may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9.

At block 1204, the MBSR determines the positioning information by performing positioning functions of a gNB, e.g., as discussed in stage 11 of FIG. 7 and stages 15 and 28 of FIG. 8. A means for determining the positioning information by performing positioning functions of a gNB may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9.

At block 1206, the MBSR returns the positioning information to the location server via the donor gNB, where the positioning information enables positioning of the UE, e.g., as discussed in stage 14 of FIG. 7 and stage 31 of FIG. 8. A means for returning the positioning information to the location server via the donor gNB, where the positioning information enables positioning of the UE may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9.

In one implementation, the MBSR may receive an MBSR TRP ID and a request for transmission reception point (TRP) capabilities from the location server via the donor gNB, e.g., as discussed in stage 5 of FIG. 7 and stage 6 of FIG. 8, and sends positioning capabilities of the MBSR and the MBSR TRP ID to the location server via the donor gNB, where the positioning capabilities indicate that the MBSR can function as a TRP and can support: (i) on demand downlink (DL) positioning reference signals (PRS) and includes on demand DL PRS parameters supported by the MBSR; (ii) measurement of uplink sounding reference signals (UL-SRS) transmitted by the target UE; or (ii) both of these, e.g., as discussed in stage 5 of FIG. 7 and stage 7 of FIG. 8. A means for receiving an MBSR TRP ID and a request for transmission reception point (TRP) capabilities from the location server via the donor gNB, and a means for sending positioning capabilities of the MBSR and the MBSR TRP ID to the location server via the donor gNB, where the positioning capabilities indicate that the MBSR can function as a TRP and can support: (i) on demand downlink (DL) positioning reference signals (PRS) and includes on demand DL PRS parameters supported by the MBSR; (ii) measurement of uplink sounding reference signals (UL-SRS) transmitted by the target UE; or (ii) both of these, may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9.

In one implementation, the MBSR receives a request for downlink (DL) positioning reference signals (PRS) transmission with transmission characteristics of the DL PRS from the location server via the donor gNB, and may transmit the DL PRS, e.g., as discussed in stage 7 of FIG. 7 and stage 10 of FIG. 8. A means for receiving a request for downlink (DL) positioning reference signals (PRS) transmission with transmission characteristics of the DL PRS from the location server via the donor gNB may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9.

In one implementation, the MBSR receives a request for transmission characteristics of uplink (UL) sounding reference signals (SRS) to be transmitted by the target UE, e.g., as discussed in stage 7 of FIG. 7 and stage 14 of FIG. 8. The MBSR determines an UL SRS configuration based on the received transmission characteristics of UL SRS, e.g., as discussed in stage 7 of FIG. 7 and stage 15 of FIG. 8. The MBSR sends the UL SRS configuration to the target UE, e.g., as discussed in stage 7 of FIG. 7 and stage 16 of FIG. 8. The MBSR sends to the location server via the donor gNB, the UL SRS configuration, e.g., as discussed in stage 7 of FIG. 7 and stage 17 of FIG. 8. A means for receiving a request for transmission characteristics of uplink (UL) sounding reference signals (SRS) to be transmitted by the target UE may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9. A means for determining a UL SRS configuration based on the received transmission characteristics of UL SRS may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9. A means for sending the UL SRS configuration to the target UE may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9. A means for sending to the location server via the donor gNB the UL SRS configuration may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9.

In one implementation, the MBSR receives a positioning activation request for the target UE from the location server via the donor gNB, the positioning activation request comprising a request for uplink (UL) sounding reference signals (SRS) transmission by the target UE, e.g., as discussed in stage 7 of FIG. 7 and stage 20 of FIG. 8. The MBSR sends the request for UL SRS transmission to the target UE, e.g., as discussed in stage 7 of FIG. 7 and stage 21 of FIG. 8. The MBSR sends a positioning activation response to the location server via the donor gNB, the positioning activation response comprising a confirmation of UL SRS activation, e.g., as discussed in stage 7 of FIG. 7 and stage 22 of FIG. 8. A means for receiving a positioning activation request for the target UE from the location server via the donor gNB, the positioning activation request comprising a request for uplink (UL) sounding reference signals (SRS) transmission by the target UE may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9. A means for sending the request for UL SRS transmission to the target UE may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9. A means for sending a positioning activation response to the location server via the donor gNB, the positioning activation response comprising a confirmation of UL SRS activation may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9.

In one implementation, the MBSR receives uplink (UL) sounding reference signals (SRS) transmitted by the target UE, e.g., as discussed in stage 11 of FIG. 7 and stage 28 of FIG. 8. The MBSR performs UL SRS measurements, wherein the positioning information comprises the UL SRS measurements, e.g., as discussed in stage 11 of FIG. 7 and stage 28 of FIG. 8. A means for receiving uplink (UL) sounding reference signals (SRS) transmitted by the target UE may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9. A means for performing UL SRS measurements, wherein the positioning information comprises the UL SRS measurements may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9.

In one implementation, the request for positioning information may include a request for round trip time (RTT) measurements, e.g., as discussed in stage 8 of FIG. 7 and stage 25 of FIG. 8. The MBSR may transmit downlink (DL) positioning reference signal (PRS) to the target UE, and the UL SRS measurements may include RTT receive transmit (Rx-Tx) measurements, e.g., as discussed in stage 11 of FIG. 7 and stage 28 of FIG. 8. A means for transmitting downlink (DL) positioning reference signal (PRS) to the target UE may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9.

In one implementation, the UL SRS measurements may include angle of arrival (AOA) measurements, e.g., as discussed in stage 11 of FIG. 7 and stage 28 of FIG. 8.

In one implementation, the positioning information may further include a location of the MBSR at a time of performing the UL SRS measurements, a velocity of the MBSR at the time of performing the UL SRS measurements, a location history of the MBSR including the time of performing the UL SRS measurements, or some combination of these, e.g., as discussed in stages 11 and 14 of FIG. 7 and stages 28 and 30 of FIG. 8.

In one implementation, the MBSR may receive a request from the location server for: a location of the MBSR at a time of performing the UL SRS measurements or at a time of transmitting DL PRS, a location history of the MBSR including the time of performing the UL SRS measurements or including the time of transmitting the DL PRS, or both of these, e.g., as discussed in stage 15 of FIG. 7 and stages 30 and 31 of FIG. 8. The MBSR may send to the location server information responsive to the information request (e.g. where the information may comprise the location of the MBSR at the time of performing the UL SRS measurements or at the time of transmitting the DL PRS, and/or the location history of the MBSR including the time of performing the UL SRS measurements or including the time of transmitting the DL PRS), e.g., as discussed in stage 15 of FIG. 7 and stages 30 and 31 of FIG. 8. A means for receiving a request from the location server for; a location of the MBSR at a time of performing the UL SRS measurements, a location history of the MBSR including the time of performing the UL SRS measurements, or both of these, may include, e.g., any of wireless transceivers 910, 911, 912, and 913, the SPS receiver 914, and one or more processors 902 with dedicated hardware or implementing executable code or software instructions in memory 904 and/or medium 920 in MBSR 900, such as the positioning session module 922, shown in FIG. 9. A means for sending to the location server information responsive to the information request may include, e.g., any of wireless transceivers 910, 911, 912, and 913 and one or more processors 902 with dedicated hardware or implementing executable code or software instructions in memory 904 and/or medium 920 in MBSR 900, such as the positioning session module 922, shown in FIG. 9.

FIG. 13 shows a process flow 1300 for an exemplary method for positioning of a target UE, performed by a donor gNB in a wireless network, such as donor gNB 110a shown in shown in FIGS. 1, 7 and 8 or donor gNB 1000 shown in FIG. 10, in a manner consistent with disclosed implementations.

At block 1302, the donor gNB receives a request for positioning information from a location server (e.g. an LMF 120) related to positioning of the target UE (e.g. UE 105), e.g., as discussed in stage 8 of FIG. 7 and stages 5, 9, 13 and 24 of FIG. 8. A means for receiving a request for positioning information from a location server related to positioning of the target UE may include, e.g., any of the external interface, including one of transceiver 1010 or communications interface 1016, and one or more processors 1002 with dedicated hardware or implementing executable code or software instructions in memory 1004 and/or medium 1020 in donor gNB 1000, such as the positioning session module 1022, shown in FIG. 10.

At block 1304, the donor gNB sends the request for positioning information to a mobile base station relay (MBSR) used by the target UE to access the wireless network, e.g., as discussed in stages 5, 7 and 8 of FIG. 7 and stages 6, 10, 14 and 25 of FIG. 8. A means for sending the request for positioning information to a mobile base station relay (MBSR) used by the target UE to access the wireless network may include, e.g., transceiver 1010 and one or more processors 1002 with dedicated hardware or implementing executable code or software instructions in memory 1004 and/or medium 1020 in donor gNB 1000, such as the positioning session module 1022, shown in FIG. 10.

At block 1306, the donor gNB receives from the MBSR the positioning information, e.g., as discussed in stages 5, 7 and 14 of FIG. 7 and stages 7, 11, 17 and 30 of FIG. 8. A means for receiving from the MBSR the positioning information may include, e.g., transceiver 1010 and one or more processors 1002 with dedicated hardware or implementing executable code or software instructions in memory 1004 and/or medium 1020 in donor gNB 1000, such as the positioning session module 1022, shown in FIG. 10.

At block 1308, the donor gNB sends the positioning information to the location server, wherein the positioning information enables positioning of the UE, e.g., as discussed in stage 5, 7 and 14 of FIG. 7 and stages 8, 12, 18 and 31 of FIG. 8. A means for sending the positioning information to the location server, wherein the positioning information enables positioning of the UE may include, e.g., any of the external interface, including one of transceiver 1010 or communications interface 1016, and one or more processors 1002 with dedicated hardware or implementing executable code or software instructions in memory 1004 and/or medium 1020 in donor gNB 1000, such as the positioning session module 1022, shown in FIG. 10.

In one implementation, the donor gNB receives a request for transmission reception point (TRP) capabilities from the location server, e.g., as discussed in stage 5 of FIG. 7 and stage 5 of FIG. 8. The donor gNB assigns a TRP ID to the MBSR, e.g., as discussed in stage 5 of FIG. 7 and stage 6 of FIG. 8. The donor gNB sends the request for transmission reception point (TRP) capabilities with the TRP ID to the MBSR, e.g., as discussed in stage 5 of FIG. 7 and stage 6 of FIG. 8. The donor gNB receives from the MBSR positioning capabilities of the MBSR, wherein the positioning capabilities indicate that the MBSR can function as a TRP and may support on demand downlink (DL) positioning reference signals (PRS) and includes on demand DL PRS parameters supported by the MBSR, e.g., as discussed in stage 5 of FIG. 7 and stage 7 of FIG. 8. The donor gNB sends the positioning capabilities of the MBSR and the TRP ID to the location server, e.g., as discussed in stage 5 of FIG. 7 and stage 8 of FIG. 8. For example, the request for TRP capabilities may be received from the location server and the positioning capabilities of the MBSR and the TRP ID may be sent to the location server using UE associated signaling or using non-UE associated signaling, e.g., as discussed in stage 5 of FIG. 7 and stages 5 and 8 of FIG. 8. A means for receiving a request for transmission reception point (TRP) capabilities from the location server may include, e.g., any of the external interface, including one of transceiver 1010 and one or more processors 1002 with dedicated hardware or implementing executable code or software instructions in memory 1004 and/or medium 1020 in donor gNB 1000, such as the positioning session module 1022, shown in FIG. 10. A means for assigning a TRP ID to the MBSR may include, e.g., one or more processors 1002 with dedicated hardware or implementing executable code or software instructions in memory 1004 and/or medium 1020 in donor gNB 1000, such as the positioning session module 1022, shown in FIG. 10. A means for sending the request for transmission reception point (TRP) capabilities with the TRP ID to the MBSR may include, e.g., the transceiver 1010 and one or more processors 1002 with dedicated hardware or implementing executable code or software instructions in memory 1004 and/or medium 1020 in donor gNB 1000, such as the positioning session module 1022, shown in FIG. 10. A means for receiving from the MBSR positioning capabilities of the MBSR, wherein the positioning capabilities indicate that the MBSR can function as a TRP and may support on demand downlink (DL) positioning reference signals (PRS) and includes on demand DL PRS parameters supported by the MBSR may include, e.g., transceiver 1010 and one or more processors 1002 with dedicated hardware or implementing executable code or software instructions in memory 1004 and/or medium 1020 in donor gNB 1000, such as the positioning session module 1022, shown in FIG. 10. A means for sending the positioning capabilities of the MBSR and the TRP ID to the location server may include, e.g., any of the external interface, including one of transceiver 1010 or communications interface 1016, and one or more processors 1002 with dedicated hardware or implementing executable code or software instructions in memory 1004 and/or medium 1020 in donor gNB 1000, such as the positioning session module 1022, shown in FIG. 10.

In one implementation, the donor gNB may receive from the location server a request for downlink (DL) positioning reference signals (PRS) transmissions by the MBSR with transmission characteristics of the DL PRS, e.g., as discussed in stage 7 of FIG. 7 and stage 9 of FIG. 8. The donor gNB may send the request for DL PRS with transmission characteristics of the DL PRS to the MBSR, e.g., as discussed in stage 7 of FIG. 7 and stage 10 of FIG. 8. A means for receiving from the location server a request for downlink (DL) positioning reference signals (PRS) transmissions by the MBSR with transmission characteristics of the DL PRS may include, e.g., any of the external interface, including one of transceiver 1010 or communications interface 1016, and one or more processors 1002 with dedicated hardware or implementing executable code or software instructions in memory 1004 and/or medium 1020 in donor gNB 1000, such as the positioning session module 1022, shown in FIG. 10. A means for sending the request for DL PRS with transmission characteristics of the DL PRS to the MBSR may include, e.g., transceiver 1010 and one or more processors 1002 with dedicated hardware or implementing executable code or software instructions in memory 1004 and/or medium 1020 in donor gNB 1000, such as the positioning session module 1022, shown in FIG. 10.

In one implementation, the donor gNB receives a request for transmission characteristics of uplink (UL) sounding reference signals (SRS), e.g., as discussed in stage 7 of FIG. 7 and stage 13 of FIG. 8. The donor gNB may send the request for transmission characteristics of UL SRS to the MBSR, e.g., as discussed in stage 7 of FIG. 7 and stage 14 of FIG. 8. The donor gNB may receive from the MBSR an UL SRS configuration, e.g., as discussed in stage 7 of FIG. 7 and stage 17 of FIG. 8. The donor gNB may send the UL SRS configuration to the location server, e.g., as discussed in stage 7 of FIG. 7 and stage 18 of FIG. 8. A means for receiving a request for transmission characteristics of uplink (UL) sounding reference signals (SRS) may include, e.g., any of the external interface, including one of transceiver 1010 or communications interface 1016, and one or more processors 1002 with dedicated hardware or implementing executable code or software instructions in memory 1004 and/or medium 1020 in donor gNB 1000, such as the positioning session module 1022, shown in FIG. 10. A means for sending the request for transmission characteristics of the UL SRS to the MBSR may include, e.g., transceiver 1010 and one or more processors 1002 with dedicated hardware or implementing executable code or software instructions in memory 1004 and/or medium 1020 in donor gNB 1000, such as the positioning session module 1022, shown in FIG. 10. A means for receiving from the MBSR an UL SRS configuration may include, e.g., transceiver 1010 and one or more processors 1002 with dedicated hardware or implementing executable code or software instructions in memory 1004 and/or medium 1020 in donor gNB 1000, such as the positioning session module 1022, shown in FIG. 10. A means for sending the UL SRS configuration to the location server may include, e.g., any of the external interface, including one of transceiver 1010 or communications interface 1016, and one or more processors 1002 with dedicated hardware or implementing executable code or software instructions in memory 1004 and/or medium 1020 in donor gNB 1000, such as the positioning session module 1022, shown in FIG. 10.

In one implementation, the donor gNB may receive a positioning activation request for the target UE from the location server, the positioning activation request comprising a request for uplink (UL) sounding reference signals (SRS) transmission by the target UE, e.g., as discussed in stage 7 of FIG. 7 and stage 19 of FIG. 8. The donor gNB may sending the positioning activation request for the target UE to the MBSR, e.g., as discussed in stage 7 of FIG. 7 and stage 20 of FIG. 8. The donor gNB may receive a positioning activation response from the MBSR, the positioning activation response comprising a confirmation of UL SRS activation, e.g., as discussed in stage 7 of FIG. 7 and stage 22 of FIG. 8. The donor gNB may send the positioning activation response to the location server, e.g., as discussed in stage 7 of FIG. 7 and stage 23 of FIG. 8. A means for receiving a positioning activation request for the target UE from the location server, the positioning activation request comprising a request for uplink (UL) sounding reference signals (SRS) transmission by the target UE may include, e.g., any of the external interface, including one of transceiver 1010 or communications interface 1016, and one or more processors 1002 with dedicated hardware or implementing executable code or software instructions in memory 1004 and/or medium 1020 in donor gNB 1000, such as the positioning session module 1022, shown in FIG. 10. A means for sending the positioning activation request for the target UE to the MBSR may include, e.g., transceiver 1010 and one or more processors 1002 with dedicated hardware or implementing executable code or software instructions in memory 1004 and/or medium 1020 in donor gNB 1000, such as the positioning session module 1022, shown in FIG. 10. A means for receiving a positioning activation response from the MBSR, the positioning activation response comprising a confirmation of UL SRS activation may include, e.g., transceiver 1010 and one or more processors 1002 with dedicated hardware or implementing executable code or software instructions in memory 1004 and/or medium 1020 in donor gNB 1000, such as the positioning session module 1022, shown in FIG. 10. A means for sending the positioning activation response to the location server may include, e.g., any of the external interface, including one of transceiver 1010 or communications interface 1016, and one or more processors 1002 with dedicated hardware or implementing executable code or software instructions in memory 1004 and/or medium 1020 in donor gNB 1000, such as the positioning session module 1022, shown in FIG. 10.

In one implementation, the positioning information comprises uplink (UL) sounding reference signals (SRS) measurements performed by the MBSR for UL SRS transmitted by the target UE, e.g., as discussed in stage 11 of FIG. 7 and stage 28 of FIG. 8.

In one implementation, the request for positioning information comprises a request for round trip time (RTT) measurements, wherein the UL SRS measurements comprise RTT receive transmit (Rx-Tx) measurements, e.g., as discussed in stage 8 of FIG. 7 and stage 24 of FIG. 8.

In one implementation, the UL SRS measurements may be angle of arrival (AOA) measurements, e.g., as discussed in stage 11 of FIG. 7 and stage 28 of FIG. 8.

In one implementation, the positioning information may further include: a location of the MBSR at a time of performing the UL SRS measurements, a velocity of the MBSR at the time of performing the UL SRS measurements, a location history of the MBSR including the time of performing the UL SRS measurements, or some combination of these, e.g., as discussed in stages 11 and 14 of FIG. 7 and stages 28, 30, and 31 of FIG. 8.

In one implementation, the donor gNB may receive from the location server a request for: a location of the MBSR at a time of performing the UL SRS measurements, and a location history of the MBSR including the time of performing the UL SRS measurements, e.g., as discussed in stage 15 of FIG. 7 and stages 30 and 31 of FIG. 8. The donor gNB may send to the MBSR the request for the at least one of the location of the MBSR at the time of performing the UL SRS measurements and the location history of the MBSR including the time of performing the UL SRS measurements, e.g., as discussed in stage 15 of FIG. 7 and stages 30 and 31 of FIG. 8. The donor gNB may receive from the MBSR the at least one of the location of the MBSR at the time of performing the UL SRS measurements and the location history of the MBSR including the time of performing the UL SRS measurements, e.g., as discussed in stage 15 of FIG. 7 and stages 30 and 31 of FIG. 8. The donor gNB may send to the location server the at least one of the location of the MBSR at the time of performing the UL SRS measurements and the location history of the MBSR including the time of performing the UL SRS measurements, e.g., as discussed in stage 15 of FIG. 7 and stages 30 and 31 of FIG. 8. A means for receiving from the location server a request for at least one of a location of the MBSR at a time of performing the UL SRS measurements and a location history of the MBSR including the time of performing the UL SRS measurements may include, e.g., any of the external interface, including one of transceiver 1010 or communications interface 1016, and one or more processors 1002 with dedicated hardware or implementing executable code or software instructions in memory 1004 and/or medium 1020 in donor gNB 1000, such as the positioning session module 1022, shown in FIG. 10. A means for sending to the MBSR the request for the at least one of the location of the MBSR at the time of performing the UL SRS measurements and the location history of the MBSR including the time of performing the UL SRS measurements may include, e.g., transceiver 1010 and one or more processors 1002 with dedicated hardware or implementing executable code or software instructions in memory 1004 and/or medium 1020 in donor gNB 1000, such as the positioning session module 1022, shown in FIG. 10. A means for receiving from the MBSR the at least one of the location of the MBSR at the time of performing the UL SRS measurements and the location history of the MBSR including the time of performing the UL SRS measurements may include, e.g., transceiver 1010 and one or more processors 1002 with dedicated hardware or implementing executable code or software instructions in memory 1004 and/or medium 1020 in donor gNB 1000, such as the positioning session module 1022, shown in FIG. 10. A means for sending to the location server the at least one of the location of the MBSR at the time of performing the UL SRS measurements and the location history of the MBSR including the time of performing the UL SRS measurements may include, e.g., any of the external interface, including one of transceiver 1010 or communications interface 1016, and one or more processors 1002 with dedicated hardware or implementing executable code or software instructions in memory 1004 and/or medium 1020 in donor gNB 1000, such as the positioning session module 1022, shown in FIG. 10.

FIG. 14 shows a process flow 1400 for an exemplary method for positioning of a target UE (e.g. a UE 105), performed by a location server in a wireless network, such as LMF 120 shown in shown in FIGS. 1, 7 and 8 or location server 1100 shown in FIG. 11, in a manner consistent with disclosed implementations.

At block 1402, the location server sends a request for positioning information related to positioning of the target UE to a mobile base station relay (MBSR) such as MBSR 104 via a donor gNB (e.g. gNB 110a), where the target UE is accessing the wireless network via the MBSR, e.g., as discussed in stages 4, 5, 7 and 8 of FIG. 7 and stages 5 and 6, 9 and 10, 13 and 14, and 24 and 25 of FIG. 8. A means for sending a request for positioning information related to positioning of the target UE to an MBSR via a donor gNB, where the target UE us accessing the wireless network via the MBSR may include, e.g., any of the external interface 1110 and one or more processors 1102 with dedicated hardware or implementing executable code or software instructions in memory 1104 and/or medium 1120 in location server 1100, such as the positioning session module 1122, shown in FIG. 11.

At block 1404, the location server receives from the MBSR via the donor gNB the positioning information, e.g., as discussed in stages 4, 5, 7 and 14 of FIG. 7 and stages 7 and 8, 11 and 12, 17 and 18, and 30 and 31 of FIG. 8. A means for receiving from the MBSR via the donor gNB the positioning information may include, e.g., any of the external interface 1110 and one or more processors 1102 with dedicated hardware or implementing executable code or software instructions in memory 1104 and/or medium 1120 in location server 1100, such as the positioning session module 1122, shown in FIG. 11.

At block 1406, the location server determines a location of the target UE based on at least partially on the positioning information received from the MBSR, e.g., as discussed in stage 16 of FIG. 7 and stage 33 of FIG. 8. A means for determining a location of the target UE based on at least partially on the positioning information received from the MBSR may include, e.g., any of the external interface 1110 and one or more processors 1102 with dedicated hardware or implementing executable code or software instructions in memory 1104 and/or medium 1120 in location server 1100, such as the positioning session module 1122, shown in FIG. 11.

In one implementation, the location server receives an indication that the target UE accesses the wireless network via the MBSR, e.g., as discussed at stages 3 and 4 of FIG. 7 or stages 3 and 4 of FIG. 8. The location server sends a request for transmission reception point (TRP) capabilities to the MBSR via the donor gNB in response to the indication that the target UE accesses the wireless network via the MBSR, e.g., as discussed in stage 5 of FIG. 7 and stages 5 and 6 of FIG. 8. The location server receives from the MBSR via the donor gNB positioning capabilities of the MBSR and a MBSR TRP ID, wherein the positioning capabilities indicate that the MBSR can function as a TRP and can support on-demand downlink (DL) positioning reference signals (PRS) and includes on-demand DL PRS parameters supported by the MBSR server, e.g., as discussed in stage 5 of FIG. 7 and stages 7 and 8 of FIG. 8. The request for TRP capabilities is sent to the MBSR via the donor gNB and the positioning capabilities of the MBSR and the MBSR TRP ID is received from the MBSR via the donor gNB using UE-associated signaling or using non-UE associated signaling, e.g., as discussed in stage 5 of FIG. 7 and stages 7 and 8 of FIG. 8. A means for receiving an indication that the target UE accesses the wireless network via the MBSR may include, e.g., any of the external interface 1110 and one or more processors 1102 with dedicated hardware or implementing executable code or software instructions in memory 1104 and/or medium 1120 in location server 1100, such as the positioning session module 1122, shown in FIG. 11. A means for sending a request for transmission reception point (TRP) capabilities to the MBSR via the donor gNB in response to the indication that the target UE accesses the wireless network via the MBSR may include, e.g., any of the external interface 1110 and one or more processors 1102 with dedicated hardware or implementing executable code or software instructions in memory 1104 and/or medium 1120 in location server 1100, such as the positioning session module 1122, shown in FIG. 11. A means for receiving from the MBSR via the donor gNB positioning capabilities of the MBSR and a MBSR TRP ID, wherein the positioning capabilities indicate that the MBSR can function as a TRP and can support on-demand downlink (DL) positioning reference signals (PRS) and includes on-demand DL PRS parameters supported by the MBSR may include, e.g., any of the external interface 1110 and one or more processors 1102 with dedicated hardware or implementing executable code or software instructions in memory 1104 and/or medium 1120 in location server 1100, such as the positioning session module 1122, shown in FIG. 11.

In one implementation, the location server sends to the MBSR via the donor gNB a request for downlink (DL) positioning reference signals (PRS) transmission by the MBSR with transmission characteristics of the DL PRS, e.g., as discussed in stage 7 of FIG. 7 and stages 9 and 10 of FIG. 8. A means for sending to the MBSR via the donor gNB a request for downlink (DL) positioning reference signals (PRS) transmission by the MBSR with transmission characteristics of the DL PRS may include, e.g., any of the external interface 1110 and one or more processors 1102 with dedicated hardware or implementing executable code or software instructions in memory 1104 and/or medium 1120 in location server 1100, such as the positioning session module 1122, shown in FIG. 11.

In one implementation, the location server sends to the MBSR via the donor gNB a request for transmission characteristics of uplink (UL) sounding reference signals (SRS)), e.g., as discussed in stage 7 of FIG. 7 and stages 13 and 14 of FIG. 8. The location server receives from the MBSR via the donor gNB a UL SRS configuration, e.g., as discussed in stage 7 of FIG. 7 and stages 17 and 18 of FIG. 8. A means for sending to the MBSR via the donor gNB a request for transmission characteristics of uplink (UL) sounding reference signals (SRS) may include, e.g., any of the external interface 1110 and one or more processors 1102 with dedicated hardware or implementing executable code or software instructions in memory 1104 and/or medium 1120 in location server 1100, such as the positioning session module 1122, shown in FIG. 11. A means for receiving from the MBSR via the donor gNB an UL SRS configuration may include, e.g., any of the external interface 1110 and one or more processors 1102 with dedicated hardware or implementing executable code or software instructions in memory 1104 and/or medium 1120 in location server 1100, such as the positioning session module 1122, shown in FIG. 11.

In one implementation, the location server sends a positioning activation request for the target UE to the MBSR via the donor gNB, the positioning activation request comprising a request for uplink (UL) sounding reference signals (SRS) transmission by the target UE, e.g., as discussed in stage 7 of FIG. 7 and stages 19 and 20 of FIG. 8. The location server receives a positioning activation response from the MBSR via the donor gNB, the positioning activation response comprising a confirmation of UL SRS activation, e.g., as discussed in stage 7 of FIG. 7 and stages 22 and 23 of FIG. 8. A means for sending a positioning activation request for the target UE to the MBSR via the donor gNB, the positioning activation request comprising a request for uplink (UL) sounding reference signals (SRS) transmission by the target UE may include, e.g., any of the external interface 1110 and one or more processors 1102 with dedicated hardware or implementing executable code or software instructions in memory 1104 and/or medium 1120 in location server 1100, such as the positioning session module 1122, shown in FIG. 11. A means for receiving a positioning activation response from the MBSR via the donor gNB, the positioning activation response comprising a confirmation of UL SRS activation may include, e.g., any of the external interface 1110 and one or more processors 1102 with dedicated hardware or implementing executable code or software instructions in memory 1104 and/or medium 1120 in location server 1100, such as the positioning session module 1122, shown in FIG. 11.

In one implementation, the positioning information comprises uplink (UL) sounding reference signals (SRS) measurements performed by the MBSR for UL SRS transmitted by the target UE, e.g., as discussed in stage 11 of FIG. 7 and stage 28 of FIG. 8.

In one implementation, the request for positioning information comprises a request for round trip time (RTT) measurements, wherein the UL SRS measurements comprise RTT receive transmit (Rx-Tx) measurements, e.g., as discussed in stage 8 of FIG. 7 and stage 24 of FIG. 8.

In one implementation, the UL SRS measurements comprise angle of arrival (AOA) measurements, e.g., as discussed in stage 11 of FIG. 7 and stage 28 of FIG. 8.

In one implementation, the positioning information further comprises at least one of a location of the MBSR at a time of performing the UL SRS measurements, a velocity of the MBSR at the time of performing the UL SRS measurements, and a location history of the MBSR including the time of performing the UL SRS measurements, e.g., as discussed in stages 11 and 14 of FIG. 7 and stages 28, 30, and 31 of FIG. 8.

In one implementation, the location server sends to the MBSR via the donor gNB a request for at least one of a location of the MBSR at a time of performing the UL SRS measurements and a location history of the MBSR including the time of performing the UL SRS measurements, e.g., as discussed in stage 15 of FIG. 7 and stages 30 and 31 of FIG. 8. The location server receives from the MBSR via the donor gNB the at least one of the location of the MBSR at the time of performing the UL SRS measurements and the location history of the MBSR including the time of performing the UL SRS measurements, e.g., as discussed in stage 15 of FIG. 7 and stages 30 and 31 of FIG. 8. A means for sending to the MBSR via the donor gNB a request for at least one of a location of the MBSR at a time of performing the UL SRS measurements and a location history of the MBSR including the time of performing the UL SRS measurements may include, e.g., any of the external interface 1110 and one or more processors 1102 with dedicated hardware or implementing executable code or software instructions in memory 1104 and/or medium 1120 in location server 1100, such as the positioning session module 1122, shown in FIG. 11. A means for receiving from the MBSR via the donor gNB the at least one of the location of the MBSR at the time of performing the UL SRS measurements and the location history of the MBSR including the time of performing the UL SRS measurements may include, e.g., any of the external interface 1110 and one or more processors 1102 with dedicated hardware or implementing executable code or software instructions in memory 1104 and/or medium 1120 in location server 1100, such as the positioning session module 1122, shown in FIG. 11.

In one implementation, at least one of a location of the MBSR at a time of performing the UL SRS measurements, a velocity of the MBSR at the time of performing the UL SRS measurements, and a location history of the MBSR including the time of performing the UL SRS measurements is received from the MBSR, e.g., as discussed in stage 15 of FIG. 7 and stages 30 and 31 of FIG. 8. The location server receives from the target UE downlink (DL) positioning reference signals (PRS) measurements of DL PRS received by the target UE from the MBSR, e.g., as discussed in stage 13 of FIG. 7 and stage 29 of FIG. 8. The location server determines the location of the target UE further based on the DL PRS measurements and the at least one of the location of the MBSR at the time of performing the UL SRS measurements, the velocity of the MBSR at the time of performing the UL SRS measurements, and the location history of the MBSR including the time of performing the UL SRS measurements, e.g., as discussed at stage 16 of FIG. 7 and stage 33 of FIG. 8.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general-purpose processor, a digital signal processor (DSP), an application-specific integrated circuit (ASIC), a field programmable gate array (FPGA) or another programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences, and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In view of this description embodiments may include different combinations of features. Implementation examples are described in the following numbered clauses:

Clause 1. A method performed by a mobile base station relay (MBSR) in a wireless network for positioning of a target user equipment (UE), the method comprising: receiving a request for positioning information from a location server via a donor gNB related to positioning of the target UE, the target UE accessing the wireless network via the MBSR; determining the positioning information by performing positioning functions of a gNB; and returning the positioning information to the location server via the donor gNB, wherein the positioning information enables positioning of the UE.

Clause 2. The method of clause 1, further comprising: receiving an MBSR transmission reception point (TRP) ID and a request for TRP capabilities from the location server via the donor gNB; and sending positioning capabilities of the MBSR and the MBSR TRP ID to the location server via the donor gNB, wherein the positioning capabilities indicate that the MBSR can function as a TRP and can support: on demand downlink (DL) positioning reference signals (PRS) and includes on demand DL PRS parameters supported by the MBSR; measurement of uplink sounding reference signals (UL-SRS) transmitted by the target UE; or both of these.

Clause 3. The method of any of clauses 1-2, further comprising: receiving a request for downlink (DL) positioning reference signals (PRS) transmission with transmission characteristics of the DL PRS from the location server via the donor gNB; and transmitting the DL PRS.

Clause 4. The method of any of clauses 1-3, further comprising: receiving a request for transmission characteristics of uplink (UL) sounding reference signals (SRS) to be transmitted by the target UE; determining an UL SRS configuration based on the received transmission characteristics of UL SRS; sending the UL SRS configuration to the target UE; and sending to the location server via the donor gNB, the UL SRS configuration.

Clause 5. The method of any of clauses 1-4, further comprising: receiving a positioning activation request for the target UE from the location server via the donor gNB, the positioning activation request comprising a request for uplink (UL) sounding reference signals (SRS) transmission by the target UE; sending the request for UL SRS transmission to the target UE; and sending a positioning activation response to the location server via the donor gNB, the positioning activation response comprising a confirmation of UL SRS activation.

Clause 6. The method of any of clauses 1-5, further comprising: receiving uplink (UL) sounding reference signals (SRS) transmitted by the target UE; and performing UL SRS measurements, wherein the positioning information comprises the UL SRS measurements.

Clause 7. The method of clause 6, wherein the request for positioning information comprises a request for round trip time (RTT) measurements, the method further comprising: transmitting downlink (DL) positioning reference signal (PRS) to the target UE; wherein the UL SRS measurements comprise RTT receive transmit (Rx-Tx) measurements.

Clause 8. The method of any of clauses 6-7, wherein the UL SRS measurements comprise angle of arrival (AOA) measurements.

Clause 9. The method of any of clauses 6-8, wherein the positioning information further comprises: a location of the MBSR at a time of performing the UL SRS measurements, a velocity of the MBSR at the time of performing the UL SRS measurements, a location history of the MBSR including the time of performing the UL SRS measurements, or some combination of these.

Clause 10. The method of any of clauses 6-9, further comprising: receiving a request from the location server for: a location of the MBSR at a time of performing the UL SRS measurements or a time of transmitting DL PRS, a location history of the MBSR including the time of performing the UL SRS measurements or the time of transmitting the DL PRS, or both of these; and sending to the location server information responsive to the information request.

Clause 11. A mobile base station relay (MBSR) in a wireless network configured for positioning of a target user equipment (UE), comprising: an external interface configured to wirelessly communicate with entities in a wireless network; at least one memory; at least one processor coupled to the external interface and the at least one memory, wherein the at least one processor is configured to: receive a request for positioning information from a location server via a donor gNB related to positioning of the target UE, the target UE accessing the wireless network via the MBSR; determine the positioning information by performing positioning functions of a gNB; and return the positioning information to the location server via the donor gNB, wherein the positioning information enables positioning of the UE.

Clause 12. The MBSR of clause 11, wherein the at least one processor is further configured to: receive an MBSR transmission reception point (TRP) ID and a request for TRP capabilities from the location server via the donor gNB; and send positioning capabilities of the MBSR and the MBSR TRP ID to the location server via the donor gNB, wherein the positioning capabilities indicate that the MBSR can function as a TRP and can support: on demand downlink (DL) positioning reference signals (PRS) and includes on demand DL PRS parameters supported by the MBSR, measurement of uplink sounding reference signals (UL-SRS) transmitted by the target UE, or both of these.

Clause 13. The MBSR of any of clauses 11-12, wherein the at least one processor is further configured to: receive a request for downlink (DL) positioning reference signals (PRS) transmission with transmission characteristics of the DL PRS from the location server via the donor gNB; and transmit the DL PRS.

Clause 14. The MBSR of any of clauses 11-13, wherein the at least one processor is further configured to: receive a request for transmission characteristics of uplink (UL) sounding reference signals (SRS) to be transmitted by the target UE; determine an UL SRS configuration based on the received transmission characteristics of UL SRS; send the UL SRS configuration to the target UE; and send to the location server via the donor gNB, the UL SRS configuration.

Clause 15. The MBSR of any of clauses 11-14, wherein the at least one processor is further configured to: receive a positioning activation request for the target UE from the location server via the donor gNB, the positioning activation request comprising a request for uplink (UL) sounding reference signals (SRS) transmission by the target UE; send the request for UL SRS transmission to the target UE; and send a positioning activation response to the location server via the donor gNB, the positioning activation response comprising a confirmation of UL SRS activation.

Clause 16. The MBSR of any of clauses 11-15, wherein the at least one processor is further configured to: receive uplink (UL) sounding reference signals (SRS) transmitted by the target UE; and perform UL SRS measurements, wherein the positioning information comprises the UL SRS measurements.

Clause 17. The MBSR of clause 16, wherein the request for positioning information comprises a request for round trip time (RTT) measurements, wherein the at least one processor is further configured to: transmit downlink (DL) positioning reference signal (PRS) to the target UE; wherein the UL SRS measurements comprise RTT receive transmit (Rx-Tx) measurements.

Clause 18. The MBSR of any of clauses 16-17, wherein the UL SRS measurements comprise angle of arrival (AOA) measurements.

Clause 19. The MBSR of any of clauses 16-18, wherein the positioning information further comprises: a location of the MBSR at a time of performing the UL SRS measurements, a velocity of the MBSR at the time of performing the UL SRS measurements, a location history of the MBSR including the time of performing the UL SRS measurements, or some combination of these.

Clause 20. The MBSR of any of clauses 16-19, wherein the at least one processor is further configured to: receive a request from the location server for: a location of the MBSR at a time of performing the UL SRS measurements or a time of transmitting DL PRS, a location history of the MBSR including the time of performing the UL SRS measurements or the time of transmitting the DL PRS, or both of these; and send to the location server information responsive to the information request.

Clause 21. A mobile base station relay (MBSR) in a wireless network configured for positioning of a target user equipment (UE), comprising: means for receiving a request for positioning information from a location server via a donor gNB related to positioning of the target UE, the target UE accessing the wireless network via the MBSR; means for determining the positioning information by performing positioning functions of a gNB; and means for returning the positioning information to the location server via the donor gNB, wherein the positioning information enables positioning of the UE.

Clause 22. A non-transitory storage medium including program code stored thereon, the program code is operable to configure at least one processor in mobile base station relay (MBSR) in a wireless network configured for positioning of a target user equipment (UE), the program code comprising instructions to: receive a request for positioning information from a location server via a donor gNB related to positioning of the target UE, the target UE accessing the wireless network via the MBSR; determine the positioning information by performing positioning functions of a gNB; and return the positioning information to the location server via the donor gNB, wherein the positioning information enables positioning of the UE.

Clause 23. A method performed by a donor gNB in a wireless network for positioning of a target user equipment (UE), the method comprising: receiving a request for positioning information from a location server related to positioning of the target UE; sending the request for positioning information to a mobile base station relay (MBSR) used by the target UE to access the wireless network; receiving from the MBSR the positioning information; and sending the positioning information to the location server, wherein the positioning information enables positioning of the UE.

Clause 24. The method of clause 23, further comprising: receiving a request for transmission reception point (TRP) capabilities from the location server; assigning a TRP ID to the MBSR; sending the request for transmission reception point (TRP) capabilities with the TRP ID to the MBSR; receiving from the MBSR positioning capabilities of the MBSR, wherein the positioning capabilities indicate that the MBSR can function as a TRP and can support on demand downlink (DL) positioning reference signals (PRS) and includes on demand DL PRS parameters supported by the MBSR; and sending the positioning capabilities of the MBSR and the TRP ID to the location server.

Clause 25. The method of clause 24, wherein the request for TRP capabilities is received from the location server and the positioning capabilities of the MBSR and the TRP ID is sent to the location server using UE associated signaling or using non-UE associated signaling.

Clause 26. The method of any of clauses 23-25, further comprising: receiving from the location server a request for downlink (DL) positioning reference signals (PRS) transmissions by the MBSR with transmission characteristics of the DL PRS; sending the request for DL PRS with transmission characteristics of the DL PRS to the MBSR.

Clause 27. The method of any of clauses 23-26, further comprising: receiving a request for transmission characteristics of uplink (UL) sounding reference signals (SRS); sending the request for transmission characteristics of the UL SRS to the MBSR; receiving from the MBSR an UL SRS configuration; and sending the UL SRS configuration to the location server.

Clause 28. The method of any of clauses 23-27, further comprising: receiving a positioning activation request for the target UE from the location server, the positioning activation request comprising a request for uplink (UL) sounding reference signals (SRS) transmission by the target UE; sending the positioning activation request for the target UE to the MBSR; receiving a positioning activation response from the MBSR, the positioning activation response comprising a confirmation of UL SRS activation; and sending the positioning activation response to the location server.

Clause 29. The method of any of clauses 23-28, wherein the positioning information comprises uplink (UL) sounding reference signals (SRS) measurements performed by the MBSR for UL SRS transmitted by the target UE.

Clause 30. The method of clause 29, wherein the request for positioning information comprises a request for round trip time (RTT) measurements, wherein the UL SRS measurements comprise RTT receive transmit (Rx-Tx) measurements.

Clause 31. The method of any of clauses 29-30, wherein the UL SRS measurements comprise angle of arrival (AOA) measurements.

Clause 32. The method of any of clauses 29-31, wherein the positioning information further comprises at least one of a location of the MBSR at a time of performing the UL SRS measurements, a velocity of the MBSR at the time of performing the UL SRS measurements, and a location history of the MBSR including the time of performing the UL SRS measurements.

Clause 33. The method of any of clauses 29-32, further comprising: receiving from the location server a request for at least one of a location of the MBSR at a time of performing the UL SRS measurements and a location history of the MBSR including the time of performing the UL SRS measurements; sending to the MBSR the request for the at least one of the location of the MBSR at the time of performing the UL SRS measurements and the location history of the MBSR including the time of performing the UL SRS measurements; receiving from the MBSR the at least one of the location of the MBSR at the time of performing the UL SRS measurements and the location history of the MBSR including the time of performing the UL SRS measurements; and sending to the location server the at least one of the location of the MBSR at the time of performing the UL SRS measurements and the location history of the MBSR including the time of performing the UL SRS measurements.

Clause 34. A donor gNB in a wireless network configured for positioning of a target user equipment (UE), comprising: an external interface configured to wirelessly communicate with entities in a wireless network; at least one memory; at least one processor coupled to the external interface and the at least one memory, wherein the at least one processor is configured to: receive a request for positioning information from a location server related to positioning of the target UE; send the request for positioning information to a mobile base station relay (MBSR) used by the target UE to access the wireless network; receive from the MBSR the positioning information; and send the positioning information to the location server, wherein the positioning information enables positioning of the UE.

Clause 35. The donor gNB of clause 34, wherein the at least one processor is further configured to: receive a request for transmission reception point (TRP) capabilities from the location server; assign a TRP ID to the MBSR; send the request for transmission reception point (TRP) capabilities with the TRP ID to the MBSR; receive from the MBSR positioning capabilities of the MBSR, wherein the positioning capabilities indicate that the MBSR can function as a TRP and can support on demand downlink (DL) positioning reference signals (PRS) and includes on demand DL PRS parameters supported by the MBSR; and send the positioning capabilities of the MBSR and the TRP ID to the location server.

Clause 36. The donor gNB of clause 35, wherein the request for TRP capabilities is received from the location server and the positioning capabilities of the MBSR and the TRP ID is sent to the location server using UE associated signaling or using non-UE associated signaling.

Clause 37. The donor gNB of any of clauses 34-36, wherein the at least one processor is further configured to: receive from the location server a request for downlink (DL) positioning reference signals (PRS) transmissions by the MBSR with transmission characteristics of the DL PRS; send the request for DL PRS with transmission characteristics of the DL PRS to the MBSR.

Clause 38. The donor gNB of any of clauses 34-37, wherein the at least one processor is further configured to: receive a request for transmission characteristics of uplink (UL) sounding reference signals (SRS); send the request for transmission characteristics of the UL SRS to the MBSR; receive from the MBSR an UL SRS configuration; and send the UL SRS configuration to the location server.

Clause 39. The donor gNB of any of clauses 34-38, wherein the at least one processor is further configured to: receive a positioning activation request for the target UE from the location server, the positioning activation request comprising a request for uplink (UL) sounding reference signals (SRS) transmission by the target UE; send the positioning activation request for the target UE to the MBSR; receive a positioning activation response from the MBSR, the positioning activation response comprising a confirmation of UL SRS activation; and send the positioning activation response to the location server.

Clause 40. The donor gNB of any of clauses 34-39, wherein the positioning information comprises uplink (UL) sounding reference signals (SRS) measurements performed by the MBSR for UL SRS transmitted by the target UE.

Clause 41. The donor gNB of clause 40, wherein the request for positioning information comprises a request for round trip time (RTT) measurements, wherein the UL SRS measurements comprise RTT receive transmit (Rx-Tx) measurements.

Clause 42. The donor gNB of any of clauses 40-41, wherein the UL SRS measurements comprise angle of arrival (AOA) measurements.

Clause 43. The donor gNB of any of clauses 40-42, wherein the positioning information further comprises at least one of a location of the MBSR at a time of performing the UL SRS measurements, a velocity of the MBSR at the time of performing the UL SRS measurements, and a location history of the MBSR including the time of performing the UL SRS measurements.

Clause 44. The donor gNB of any of clauses 40-43, wherein the at least one processor is further configured to: receive from the location server a request for at least one of a location of the MBSR at a time of performing the UL SRS measurements and a location history of the MBSR including the time of performing the UL SRS measurements; send to the MBSR the request for the at least one of the location of the MBSR at the time of performing the UL SRS measurements and the location history of the MBSR including the time of performing the UL SRS measurements; receive from the MBSR the at least one of the location of the MBSR at the time of performing the UL SRS measurements and the location history of the MBSR including the time of performing the UL SRS measurements; and send to the location server the at least one of the location of the MBSR at the time of performing the UL SRS measurements and the location history of the MBSR including the time of performing the UL SRS measurements.

Clause 45. A donor gNB in a wireless network configured for positioning of a target user equipment (UE), comprising: means for receiving a request for positioning information from a location server related to positioning of the target UE; means for sending the request for positioning information to a mobile base station relay (MBSR) used by the target UE to access the wireless network; means for receiving from the MBSR the positioning information; and means for sending the positioning information to the location server, wherein the positioning information enables positioning of the UE.

Clause 46. A non-transitory storage medium including program code stored thereon, the program code is operable to configure at least one processor in a donor gNB in a wireless network for positioning of a target user equipment (UE), the program code comprising instructions to: receive a request for positioning information from a location server related to positioning of the target UE; send the request for positioning information to a mobile base station relay (MBSR) used by the target UE to access the wireless network; receive from the MBSR the positioning information; and send the positioning information to the location server, wherein the positioning information enables positioning of the UE.

Clause 47. A method performed by a location server in a wireless network for positioning of a target user equipment (UE), the method comprising: sending a request for positioning information related to positioning of the target UE to a mobile base station relay (MBSR) via a donor gNB, the target UE accessing the wireless network via the MBSR; receiving from the MBSR via the donor gNB the positioning information; and determining a location of the target UE based on at least partially on the positioning information received from the MBSR.

Clause 48. The method of clause 47, further comprising: receiving an indication that the target UE accesses the wireless network via the MBSR; sending a request for transmission reception point (TRP) capabilities to the MBSR via the donor gNB in response to the indication that the target UE accesses the wireless network via the MBSR; receiving from the MBSR via the donor gNB positioning capabilities of the MBSR and a MBSR TRP ID, wherein the positioning capabilities indicate that the MBSR can function as a TRP and can support on demand downlink (DL) positioning reference signals (PRS) and includes on demand DL PRS parameters supported by the MBSR.

Clause 49. The method of clause 48, wherein the request for TRP capabilities is sent to the MBSR via the donor gNB and the positioning capabilities of the MBSR and the MBSR TRP ID is received from the MBSR via the donor gNB using UE associated signaling or using non-UE associated signaling.

Clause 50. The method of any of clauses 47-49, further comprising sending to the MBSR via the donor gNB a request for downlink (DL) positioning reference signals (PRS) transmission by the MBSR with transmission characteristics of the DL PRS.

Clause 51. The method of any of clauses 47-50, further comprising: sending to the MBSR via the donor gNB a request for transmission characteristics of uplink (UL) sounding reference signals (SRS); and receiving from the MBSR via the donor gNB an UL SRS configuration.

Clause 52. The method of any of clauses 47-51, further comprising: sending a positioning activation request for the target UE to the MBSR via the donor gNB, the positioning activation request comprising a request for uplink (UL) sounding reference signals (SRS) transmission by the target UE; receiving a positioning activation response from the MBSR via the donor gNB, the positioning activation response comprising a confirmation of UL SRS activation.

Clause 53. The method of any of clauses 47-52, wherein the positioning information comprises uplink (UL) sounding reference signals (SRS) measurements performed by the MBSR for UL SRS transmitted by the target UE.

Clause 54. The method of clause 53, wherein the request for positioning information comprises a request for round trip time (RTT) measurements, wherein the UL SRS measurements comprise RTT receive transmit (Rx-Tx) measurements.

Clause 55. The method of any of clauses 53-54, wherein the UL SRS measurements comprise angle of arrival (AOA) measurements.

Clause 56. The method of any of clauses 53-55, wherein the positioning information further comprises at least one of a location of the MBSR at a time of performing the UL SRS measurements, a velocity of the MBSR at the time of performing the UL SRS measurements, and a location history of the MBSR including the time of performing the UL SRS measurements.

Clause 57. The method of any of clauses 53-56, further comprising: sending to the MBSR via the donor gNB a request for at least one of a location of the MBSR at a time of performing the UL SRS measurements and a location history of the MBSR including the time of performing the UL SRS measurements; and receiving from the MBSR via the donor gNB the at least one of the location of the MBSR at the time of performing the UL SRS measurements and the location history of the MBSR including the time of performing the UL SRS measurements.

Clause 58. The method of any of clauses 53-57, wherein at least one of a location of the MBSR at a time of performing the UL SRS measurements, a velocity of the MBSR at the time of performing the UL SRS measurements, and a location history of the MBSR including the time of performing the UL SRS measurements is received from the MBSR, further comprising: receiving from the target UE downlink (DL) positioning reference signals (PRS) measurements of DL PRS received by the target UE from the MBSR; wherein determining the location of the target UE is further based on the DL PRS measurements and the at least one of the location of the MBSR at the time of performing the UL SRS measurements, the velocity of the MBSR at the time of performing the UL SRS measurements, and the location history of the MBSR including the time of performing the UL SRS measurements.

Clause 59. A location server in a wireless network configured for positioning of a target user equipment (UE), comprising: an external interface configured to wirelessly communicate with entities in a wireless network; at least one memory; at least one processor coupled to the external interface and the at least one memory, wherein the at least one processor is configured to: send a request for positioning information related to positioning of the target UE to a mobile base station relay (MBSR) via a donor gNB, the target UE accessing the wireless network via the MBSR; receive from the MBSR via the donor gNB the positioning information; and determine a location of the target UE based on at least partially on the positioning information received from the MBSR.

Clause 60. The location server of clause 59, wherein the at least one processor is further configured to: receive an indication that the target UE accesses the wireless network via the MBSR; send a request for transmission reception point (TRP) capabilities to the MBSR via the donor gNB in response to the indication that the target UE accesses the wireless network via the MBSR; receive from the MBSR via the donor gNB positioning capabilities of the MBSR and a MBSR TRP ID, wherein the positioning capabilities indicate that the MBSR can function as a TRP and can support on demand downlink (DL) positioning reference signals (PRS) and includes on demand DL PRS parameters supported by the MBSR.

Clause 61. The location server of clause 60, wherein the request for TRP capabilities is sent to the MBSR via the donor gNB and the positioning capabilities of the MBSR and the MBSR TRP ID is received from the MBSR via the donor gNB using UE associated signaling or using non-UE associated signaling.

Clause 62. The location server of any of clauses 59-61, wherein the at least one processor is further configured to send to the MBSR via the donor gNB a request for downlink (DL) positioning reference signals (PRS) transmission by the MBSR with transmission characteristics of the DL PRS.

Clause 63. The location server of any of clauses 59-62, wherein the at least one processor is further configured to: send to the MBSR via the donor gNB a request for transmission characteristics of uplink (UL) sounding reference signals (SRS); and receive from the MBSR via the donor gNB an UL SRS configuration.

Clause 64. The location server of any of clauses 59-63, wherein the at least one processor is further configured to: send a positioning activation request for the target UE to the MBSR via the donor gNB, the positioning activation request comprising a request for uplink (UL) sounding reference signals (SRS) transmission by the target UE; receive a positioning activation response from the MBSR via the donor gNB, the positioning activation response comprising a confirmation of UL SRS activation.

Clause 65. The location server of any of clauses 59-64, wherein the positioning information comprises uplink (UL) sounding reference signals (SRS) measurements performed by the MBSR for UL SRS transmitted by the target UE.

Clause 66. The location server of clause 65, wherein the request for positioning information comprises a request for round trip time (RTT) measurements, wherein the UL SRS measurements comprise RTT receive transmit (Rx-Tx) measurements.

Clause 67. The location server of any of clauses 65-66, wherein the UL SRS measurements comprise angle of arrival (AOA) measurements.

Clause 68. The location server of any of clauses 65-67, wherein the positioning information further comprises at least one of a location of the MBSR at a time of performing the UL SRS measurements, a velocity of the MBSR at the time of performing the UL SRS measurements, and a location history of the MBSR including the time of performing the UL SRS measurements.

Clause 69. The location server of any of clauses 65-68, wherein the at least one processor is further configured to:

Clause send to the MBSR via the donor gNB a request for at least one of a location of the MBSR at a time of performing the UL SRS measurements and a location history of the MBSR including the time of performing the UL SRS measurements; and receive from the MBSR via the donor gNB the at least one of the location of the MBSR at the time of performing the UL SRS measurements and the location history of the MBSR including the time of performing the UL SRS measurements.

Clause 70. The location server of any of clauses 65-69, wherein at least one of a location of the MBSR at a time of performing the UL SRS measurements, a velocity of the MBSR at the time of performing the UL SRS measurements, and a location history of the MBSR including the time of performing the UL SRS measurements is received from the MBSR, wherein the at least one processor is further configured to: receive from the target UE downlink (DL) positioning reference signals (PRS) measurements of DL PRS received by the target UE from the MBSR; wherein the at least one processor is configured to determine the location of the target UE further based on the DL PRS measurements and the at least one of the location of the MBSR at the time of performing the UL SRS measurements, the velocity of the MBSR at the time of performing the UL SRS measurements, and the location history of the MBSR including the time of performing the UL SRS measurements.

Clause 71. A location server in a wireless network configured for positioning of a target user equipment (UE), comprising: means for sending a request for positioning information related to positioning of the target UE to a mobile base station relay (MBSR) via a donor gNB, the target UE accessing the wireless network via the MBSR; means for receiving from the MBSR via the donor gNB the positioning information; and means for determining a location of the target UE based on at least partially on the positioning information received from the MBSR.

Clause 72. A non-transitory storage medium including program code stored thereon, the program code is operable to configure at least one processor in a location server in a wireless network for positioning of a target user equipment (UE), the program code comprising instructions to: send a request for positioning information related to positioning of the target UE to a mobile base station relay (MBSR) via a donor gNB, the target UE accessing the wireless network via the MBSR; receive from the MBSR via the donor gNB the positioning information; and determine a location of the target UE based on at least partially on the positioning information received from the MBSR.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method performed by a mobile base station relay (MBSR) in a wireless network for positioning of a target user equipment (UE), the method comprising:
receiving a request for positioning information from a location server via a donor gNB related to positioning of the target UE, the target UE accessing the wireless network via the MBSR;
determining the positioning information by performing positioning functions of a gNB; and
returning the positioning information to the location server via the donor gNB, wherein the positioning information enables positioning of the UE.

2. The method of claim 1, further comprising:
receiving an MBSR transmission reception point (TRP) ID and a request for TRP capabilities from the location server via the donor gNB; and
sending positioning capabilities of the MBSR and the MBSR TRP ID to the location server via the donor gNB, wherein the positioning capabilities indicate that the MBSR can function as a TRP and can support:
on demand downlink (DL) positioning reference signals (PRS) and includes on demand DL PRS parameters supported by the MBSR,
measurement of uplink sounding reference signals (UL-SRS) transmitted by the target UE,
or both of these.

3. The method of claim 1, further comprising:
receiving a request for downlink (DL) positioning reference signals (PRS) transmission with transmission characteristics of the DL PRS from the location server via the donor gNB;
and transmitting the DL PRS.

4. The method of claim 1, further comprising:
receiving a request for transmission characteristics of uplink (UL) sounding reference signals (SRS) to be transmitted by the target UE;
determining an UL SRS configuration based on the received transmission characteristics of UL SRS;
sending the UL SRS configuration to the target UE; and
sending to the location server via the donor gNB, the UL SRS configuration.

5. The method of claim 1, further comprising:
receiving a positioning activation request for the target UE from the location server via the donor gNB, the positioning activation request comprising a request for uplink (UL) sounding reference signals (SRS) transmission by the target UE;
sending the request for UL SRS transmission to the target UE; and
sending a positioning activation response to the location server via the donor gNB, the positioning activation response comprising a confirmation of UL SRS activation.

6. The method of claim 1, further comprising:
receiving uplink (UL) sounding reference signals (SRS) transmitted by the target UE; and
performing UL SRS measurements, wherein the positioning information comprises the UL SRS measurements.

7. The method of claim 6, wherein the request for positioning information comprises a request for round trip time (RTT) measurements, the method further comprising:
transmitting downlink (DL) positioning reference signal (PRS) to the target UE;
wherein the UL SRS measurements comprise RTT receive transmit (Rx-Tx) measurements.

8. The method of claim 6, wherein the UL SRS measurements comprise angle of arrival (AOA) measurements.

9. The method of claim 6, wherein the positioning information further comprises:
a location of the MBSR at a time of performing the UL SRS measurements,
a velocity of the MBSR at the time of performing the UL SRS measurements,
a location history of the MBSR including the time of performing the UL SRS measurements, or
some combination of these.

10. The method of claim 6, further comprising:
receiving an information request from the location server for:
a location of the MBSR at a time of performing the UL SRS measurements or a time of transmitting DL PRS,
a location history of the MBSR including the time of performing the UL SRS measurements or the time of transmitting the DL PRS, or
both of these; and
sending to the location server information responsive to the information request.

11. A mobile base station relay (MBSR) in a wireless network configured for positioning of a target user equipment (UE), comprising:
an external interface configured to wirelessly communicate with entities in a wireless network;
at least one memory;
at least one processor coupled to the external interface and the at least one memory, wherein the at least one processor is configured to:
receive a request for positioning information from a location server via a donor gNB related to positioning of the target UE, the target UE accessing the wireless network via the MBSR;
determine the positioning information by performing positioning functions of a gNB; and
return the positioning information to the location server via the donor gNB, wherein the positioning information enables positioning of the UE.

12. The MBSR of claim 11, wherein the at least one processor is further configured to:
receive an MBSR transmission reception point (TRP) ID and a request for TRP capabilities from the location server via the donor gNB; and
send positioning capabilities of the MBSR and the MBSR TRP ID to the location server via the donor gNB, wherein the positioning capabilities indicate that the MBSR can function as a TRP and can support:
on demand downlink (DL) positioning reference signals (PRS) and includes on demand DL PRS parameters supported by the MBSR,
measurement of uplink sounding reference signals (UL-SRS) transmitted by the target UE,
or both of these.

13. The MBSR of claim 11, wherein the at least one processor is further configured to:
receive a request for downlink (DL) positioning reference signals (PRS) transmission with transmission characteristics of the DL PRS from the location server via the donor gNB; and
transmit the DL PRS.

14. The MBSR of claim 11, wherein the at least one processor is further configured to:
receive a request for transmission characteristics of uplink (UL) sounding reference signals (SRS) to be transmitted by the target UE;
determine an UL SRS configuration based on the received transmission characteristics of UL SRS;
send the UL SRS configuration to the target UE; and
send to the location server via the donor gNB, the UL SRS configuration.

15. The MBSR of claim 11, wherein the at least one processor is further configured to:
receive a positioning activation request for the target UE from the location server via the donor gNB, the positioning activation request comprising a request for uplink (UL) sounding reference signals (SRS) transmission by the target UE;
send the request for UL SRS transmission to the target UE; and
send a positioning activation response to the location server via the donor gNB, the positioning activation response comprising a confirmation of UL SRS activation.

16. A method performed by a donor gNB in a wireless network for positioning of a target user equipment (UE), the method comprising:
receiving a request for positioning information from a location server related to positioning of the target UE;
sending the request for positioning information to a mobile base station relay (MBSR) used by the target UE to access the wireless network;
receiving from the MBSR the positioning information; and
sending the positioning information to the location server, wherein the positioning information enables positioning of the UE.

17. The method of claim 16, further comprising:
receiving a request for transmission reception point (TRP) capabilities from the location server;
assigning a TRP ID to the MBSR;
sending the request for transmission reception point (TRP) capabilities with the TRP ID to the MBSR;
receiving from the MBSR positioning capabilities of the MBSR, wherein the positioning capabilities indicate that the MBSR can function as a TRP and can support on demand downlink (DL) positioning reference signals (PRS) and includes on demand DL PRS parameters supported by the MBSR; and
sending the positioning capabilities of the MBSR and the TRP ID to the location server.

18. The method of claim 17, wherein the request for TRP capabilities is received from the location server and the positioning capabilities of the MBSR and the TRP ID is sent to the location server using UE associated signaling or using non-UE associated signaling.

19. The method of claim 16, further comprising:
receiving from the location server a request for downlink (DL) positioning reference signals (PRS) transmissions by the MBSR with transmission characteristics of the DL PRS;
sending the request for DL PRS with transmission characteristics of the DL PRS to the MBSR.

20. The method of claim 16, further comprising:
receiving a request for transmission characteristics of uplink (UL) sounding reference signals (SRS);
sending the request for transmission characteristics of the UL SRS to the MBSR;
receiving from the MBSR an UL SRS configuration; and
sending the UL SRS configuration to the location server.

21. The method of claim 16, further comprising:
receiving a positioning activation request for the target UE from the location server, the positioning activation request comprising a request for uplink (UL) sounding reference signals (SRS) transmission by the target UE;
sending the positioning activation request for the target UE to the MBSR;
receiving a positioning activation response from the MBSR, the positioning activation response comprising a confirmation of UL SRS activation; and
sending the positioning activation response to the location server.

22. The method of claim 16, wherein the positioning information comprises uplink (UL) sounding reference signals (SRS) measurements performed by the MBSR for UL SRS transmitted by the target UE.

23. The method of claim 22, further comprising:
receiving from the location server a request for at least one of a location of the MBSR at a time of performing the UL SRS measurements and a location history of the MBSR including the time of performing the UL SRS measurements;
sending to the MBSR the request for the at least one of the location of the MBSR at the time of performing the UL SRS measurements and the location history of the MBSR including the time of performing the UL SRS measurements;
receiving from the MBSR the at least one of the location of the MBSR at the time of performing the UL SRS measurements and the location history of the MBSR including the time of performing the UL SRS measurements; and
sending to the location server the at least one of the location of the MBSR at the time of performing the UL SRS measurements and the location history of the MBSR including the time of performing the UL SRS measurements.

24. A method performed by a location server in a wireless network for positioning of a target user equipment (UE), the method comprising:
sending a request for positioning information related to positioning of the target UE to a mobile base station relay (MBSR) via a donor gNB, the target UE accessing the wireless network via the MBSR;
receiving from the MBSR via the donor gNB the positioning information; and
determining a location of the target UE based on at least partially on the positioning information received from the MBSR.

25. The method of claim 24, further comprising:
receiving an indication that the target UE accesses the wireless network via the MBSR;
sending a request for transmission reception point (TRP) capabilities to the MBSR via the donor gNB in response to the indication that the target UE accesses the wireless network via the MBSR;
receiving from the MBSR via the donor gNB positioning capabilities of the MBSR and a MBSR TRP ID, wherein the positioning capabilities indicate that the MBSR can function as a TRP and can support on demand downlink (DL) positioning reference signals (PRS) and includes on demand DL PRS parameters supported by the MBSR.

26. The method of claim 25, wherein the request for TRP capabilities is sent to the MBSR via the donor gNB and the positioning capabilities of the MBSR and the MBSR TRP ID is received from the MBSR via the donor gNB using UE associated signaling or using non-UE associated signaling.

27. The method of claim 24, further comprising sending to the MBSR via the donor gNB a request for downlink (DL) positioning reference signals (PRS) transmission by the MBSR with transmission characteristics of the DL PRS.

28. The method of claim 24, further comprising:
sending to the MBSR via the donor gNB a request for transmission characteristics of uplink (UL) sounding reference signals (SRS); and
receiving from the MBSR via the donor gNB an UL SRS configuration.

29. The method of claim 24, further comprising:
sending a positioning activation request for the target UE to the MBSR via the donor gNB, the positioning activation request comprising a request for uplink (UL) sounding reference signals (SRS) transmission by the target UE;
receiving a positioning activation response from the MBSR via the donor gNB, the positioning activation response comprising a confirmation of UL SRS activation.

30. The method of claim 24, wherein the positioning information comprises uplink (UL) sounding reference signals (SRS) measurements performed by the MBSR for UL SRS transmitted by the target UE.
